(19) United States
(12) Patent Application Publication
(10) Pub. No.: US 2026/0093955 A1
(43) Pub. Date: Apr. 2, 2026

(54) SERVER DEVICE, TERMINAL DEVICE, INFORMATION PROCESSING METHOD, AND INFORMATION PROCESSING SYSTEM

(71) Applicant: Sony Semiconductor Solutions Corporation, Kanagawa (JP)

(72) Inventors: Munehiro SHIMOMURA, Kanagawa (JP); Hirotaka ISHIKAWA, Kanagawa (JP)

(73) Assignee: Sony Semiconductor Solutions Corporation, Kanagawa (JP)

(21) Appl. No.: 19/110,449

(22) PCT Filed: Oct. 6, 2023
(86) PCT No.: PCT/JP2023/036472

§ 371 Date: Mar. 11, 2025

(30) Foreign Application Priority Data
Oct. 14, 2022 (JP) 2022-165837

(51) Int. Cl. G06N 3/045; G06N 3/082

(52) U.S. Cl. CPC G06N 3/045; G06N 3/082

(57) ABSTRACT

An information processing system configured to transmit a first command to a first electronic device requesting processing capability information of the first electronic device; receive first parameters from the first electronic device in response to the first command; divide a deep neural network (DNN) into at least a first DNN and a second DNN based on the first parameters received from the first electronic device; and transmit the first divided DNN to the first electronic device.

### TECHNICAL FIELD

The present disclosure relates to a server device, a terminal device, an information processing method, and an information processing system.

### BACKGROUND ART

A device that performs inference processing by incorporating a deep neural network (DNN) is known. In general, inference processing using the DNN has a large calculation cost, and furthermore, a model size tends to be larger as a model can execute complicated and advanced DNN processing. Accordingly, a technique of dividing the DNN and executing inference processing in a distributed manner by a plurality of devices has been proposed.

### CITATION LIST

### Patent Literature

PTL 1: US 2020/0175361 A
PTL 2: US 2016/0034811 A
PTL 3: US 2019/0377930 A

### SUMMARY

### Technical Problem

When the DNN is divided, it is necessary to perform appropriate division according to the processing amount and the like.

An object of the present disclosure is to provide a server device, a terminal device, an information processing method, and an information processing system capable of appropriately dividing a neural network.

### Solution to Problem

According to one aspect of the present disclosure, an information processing system is disclosed, which includes circuitry configured to: transmit a first command to a first electronic device requesting processing capability information of the first electronic device; receive first parameters from the first electronic device in response to the first command; divide a deep neural network (DNN) into at least a first DNN and a second DNN based on the first parameters received from the first electronic device; and transmit the first divided DNN to the first electronic device.

### BRIEF DESCRIPTION OF DRAWINGS

FIG. 1 is a schematic diagram schematically illustrating an information processing system according to an embodiment.

FIG. 2 is a block diagram illustrating a configuration of an example of a neural network distribution server according to the embodiment.

FIG. 3 is a functional block diagram of an example for describing functions of the neural network distribution server according to the embodiment.

FIG. 4 is a block diagram illustrating a configuration of an example of an AI device according to the embodiment.

FIG. 5A is a block diagram illustrating a configuration of an example of an imaging device applicable to the embodiment.

FIG. 5B is a perspective view schematically illustrating a structure of an example of an imaging device applicable to the embodiment.

FIG. 6 is a functional block diagram of an example for describing functions of the AI device according to the embodiment.

FIG. 7 is a block diagram illustrating a configuration of an example of the AI device according to the embodiment.

FIG. 8 is a functional block diagram of an example for describing functions of the AI device according to the embodiment.

FIG. 9 is a sequence diagram illustrating an example of a basic operation sequence according to an existing technology.

FIG. 10 is a sequence diagram for describing a flow of processing in the information processing system according to the embodiment.

FIG. 11 is a flowchart of an example for describing processing in the neural network distribution server according to the embodiment.

FIG. 12 is a flowchart of an example for describing processing in the AI device according to the embodiment.

FIG. 13 is a schematic diagram for describing a processing amount of each layer, a data communication amount between respective layers, and distribution of the processing amount to each AI device according to the embodiment.

FIG. 14 is a schematic diagram for describing determination processing of a dividing position based on a processing speed of the entire neural network according to the embodiment.

FIG. 15 is a schematic diagram for describing determination processing of a dividing position based on power consumption of the entire neural network according to the embodiment.

FIG. 16 is a schematic diagram for describing determination processing of a dividing position based on a transmission speed in a transmission path 31 according to the embodiment.

FIG. 17 is a schematic diagram illustrating a configuration of an example of an information processing system according to a first modification of the embodiment.

FIG. 18 is a schematic diagram illustrating a configuration of an example of an information processing system according to a second modification of the embodiment.

FIG. 19 is a diagram illustrating an example of training and using a machine learning model in connection with image processing in accordance with embodiments of the present disclosure.

### DESCRIPTION OF EMBODIMENTS

Hereinafter, an embodiment of the present disclosure will be described in detail with reference to the drawings. Note that, in the following embodiment, the same parts are denoted by the same reference numerals, and redundant description is omitted.

Hereinafter, an embodiment of the present disclosure will be described in the following order.
1. Summary of embodiment of present disclosure
2. Configuration applicable to embodiment
2-1. Neural network distribution server
2-2. AI device
3. Existing technology
4. Embodiment of present disclosure
4-1. Flow of processing according to embodiment
4-2. Method of determining neural network dividing position according to embodiment
5. First modification of embodiment
6. Second modification of embodiment

### (1. Summary of Embodiment of Present Disclosure)

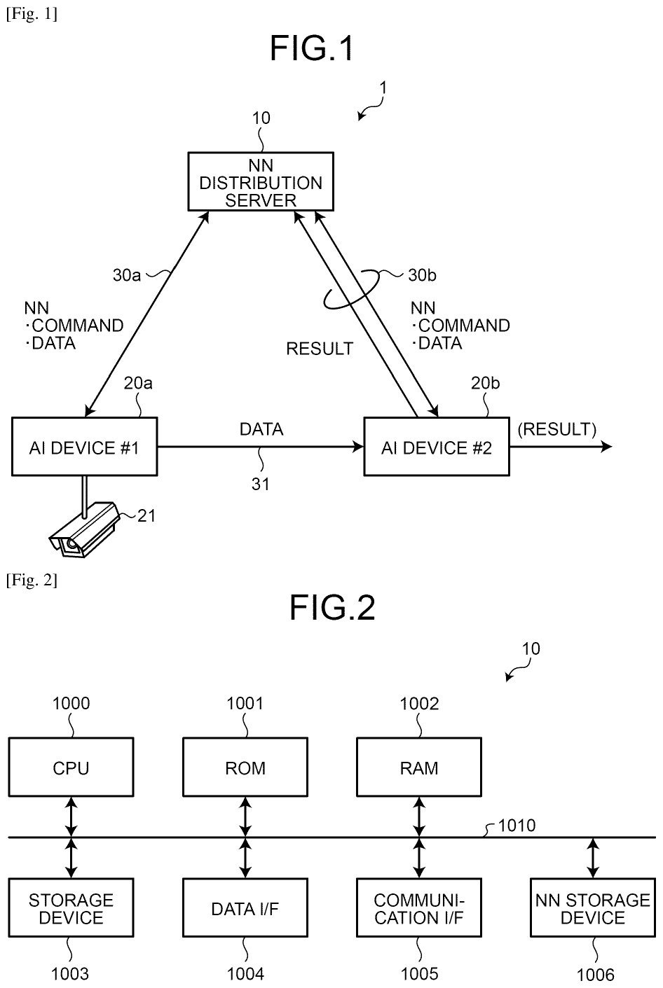

First, a summary of an embodiment of the present disclosure will be described. FIG. 1 is a schematic diagram schematically illustrating an information processing system according to the embodiment.

In FIG. 1, an information processing system 1 according to the embodiment includes a neural network distribution server 10 and artificial intelligence (AI) devices 20a and 20b. Note that, in FIG. 1 and the subsequent drawings, the AI devices 20a and 20b are also illustrated as an AI device #1 and an AI device #2, respectively. Note that, in FIG. 1, the neural network distribution server 10 is illustrated as a neural network (NN) distribution server 10.

The neural network distribution server 10 is communicably connected to the AI devices 20a and 20b via the transmission paths 30a and 30b. The transmission paths 30a and 30b are, for example, communication neural networks by wireless communication or wired communication. The transmission paths 30a and 30b may be communication networks such as the Internet and a local area network (LAN). Not limited to this, the transmission paths 30a and 30b may directly connect the neural network distribution server 10 and the AI devices 20a and 20b.

The neural network distribution server 10 distributes a neural network (indicated as NN in the drawing), which is, for example, a deep neural network (DNN), to each of the AI devices 20a and 20b via transmission paths 30a and 30b. Furthermore, the neural network distribution server 10 transmits and receives commands and data to and from the AI devices 20a and 20b via the transmission paths 30a and 30b, respectively.

Each of the AI devices 20a and 20b executes processing by the neural network by the neural network distributed from the neural network distribution server 10. The processing by the neural network executed by the AI devices 20a and 20b is, for example, inference processing using the neural network. Hereinafter, the “processing by the neural network” will be appropriately described as “neural network processing”.

The AI device 20a executes the neural network processing using, for example, a captured image captured by the camera 21 as an image input. The AI device 20a transmits data of a processing result of the neural network processing for the captured image to the AI device 20b via the transmission path 31. The AI device 20b executes the neural network processing using the processing result data transmitted from the AI device 20a as input data. The AI device 20b outputs processing result data of the neural network processing for the input data to the outside. Furthermore, the AI device 20b may output the processing result data to the neural network distribution server 10.

In such a configuration, the neural network distribution server 10 distributes one of the divided neural networks obtained by dividing the neural network at predetermined dividing positions to the AI device 20a and distributes the other to the AI device 20b. The dividing position is between adjacent layers out of the plurality of layers included in the neural network. As described above, by dividing the neural network and distributing the divided neural networks to the plurality of AI devices 20a and 20b, it is possible to reduce the load due to the neural network processing in the AI devices 20a and 20b.

Here, the neural network distribution server 10 according to the embodiment measures a processing capability related to the AI processing of the AI devices 20a and 20b using the neural network for benchmark, and determines the dividing position for dividing the neural network on the basis of the measurement result. Furthermore, the neural network distribution server 10 may acquire the capability value related to the AI processing capability of each of the AI devices 20a and 20b using an existing command, and select a neural network for benchmark on the basis of the acquired capability value and the neural network to be executed by the AI devices 20a and 20b for actual execution.

Note that the AI processing capability can be considered as processing capability related to the neural network processing.

As described above, according to the embodiment of the present disclosure, the neural network distribution server 10 measures the AI processing capabilities of the AI devices 20a and 20b using the neural network for benchmark when dividing the neural network for actual execution and distributing the divided neural networks to the plurality of AI devices. The neural network distribution server 10 determines the dividing position of the neural network for actual execution on the basis of the measurement result using the neural network for benchmark. Therefore, the neural network for actual execution can be divided at a more appropriate dividing position, and the overall performance of the neural network for actual execution can be improved.

Note that, hereinafter, the neural network for actual execution is appropriately referred to as an execution neural network, and the neural network for benchmark is appropriately referred to as a measurement neural network. Furthermore, in FIG. 1, the neural network distribution server 10 is illustrated to distribute the neural network to two AI devices 20a and 20b, but this is for the sake of description, and the neural network distribution server 10 may be configured to distribute the neural network to three or more AI devices.

### (2. Configuration Applicable to Embodiment)

Next, a configuration applicable to the embodiment will be described.

### (2-1. Neural Network Distribution Server)

A configuration example of the neural network distribution server 10 as the server device of the present disclosure will be described.

FIG. 2 is a block diagram illustrating a configuration of an example of the neural network distribution server 10 according to the embodiment. In FIG. 2, the neural network distribution server 10 includes a central processing unit (CPU) 1000, a read only memory (ROM) 1001, a random access memory (RAM) 1002, a storage device 1003, a data I/F 1004, a communication I/F 1005, and a neural network storage device 1006, and these units are communicably connected to each other via a bus 1010. Note that, in the drawing, the neural network storage device 1006 is illustrated as an NN storage device 1006.

The storage device 1003 is a nonvolatile storage medium such as a flash memory or a hard disk drive. The CPU 1000 controls the overall operation of the neural network distribution server 10 by using the RAM 1002 as a work memory according to a program stored in the storage device 1003 and the ROM 1001.

The data interface (I/F) 1004 is an interface for transmitting and receiving data to and from an external device. The communication I/F 1005 is an interface for performing communication via the transmission paths 30a and 30b.

The neural network storage device 1006 is a nonvolatile storage medium such as a flash memory or a hard disk drive, and stores the execution neural network and the measurement neural network. In FIG. 2, the neural network storage device 1006 is illustrated to be built in the neural network distribution server 10, but this is not limited to this example, and the neural network storage device 1006 may be an external device for the neural network distribution server 10.

Note that, in FIG. 2 and FIG. 1 described above, the neural network distribution server 10 is illustrated as being configured by one computer, but this is not limited to this example. The neural network distribution server 10 may be configured in a distributed manner by a plurality of computers communicably connected to each other, or may be configured by a cloud neural network including a plurality of computers and a plurality of storage devices communicably connected to each other by a neural network and capable of providing computer resources in the form of a service.

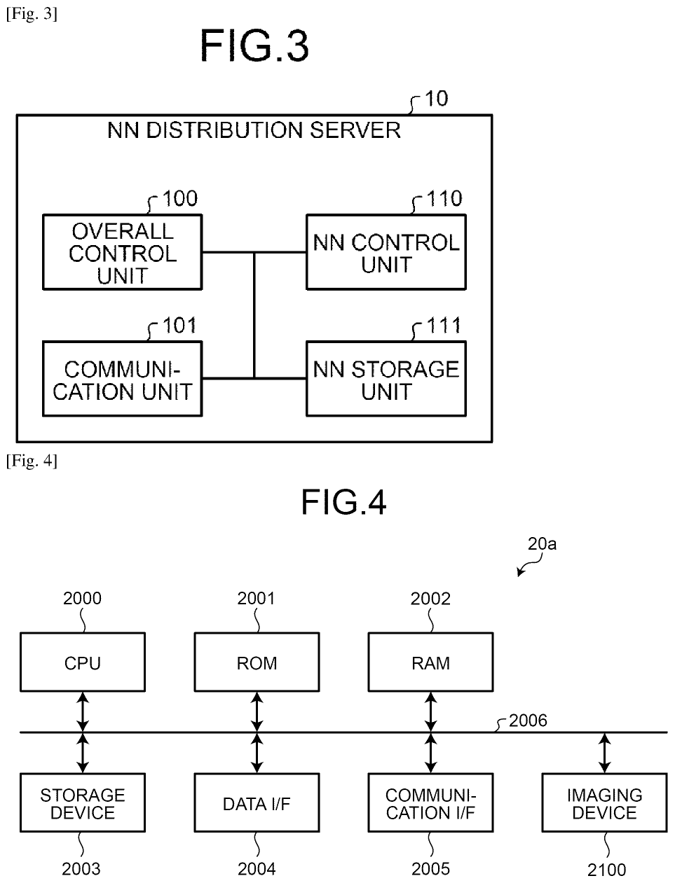

FIG. 3 is a functional block diagram of an example for describing the functions of the neural network distribution server 10 according to the embodiment. In FIG. 3, the neural network distribution server 10 includes an overall control unit 100, a communication unit 101, a neural network control unit 110, and a neural network storage unit 111. Note that, in the drawing, the neural network control unit 110 and the neural network storage unit 111 are illustrated as an NN control unit 110 and an NN storage unit 111, respectively.

The overall control unit 100, the communication unit 101, the neural network control unit 110, and the neural network storage unit 111 are configured by the operation of the information processing program for server according to the embodiment on the CPU 1000. Not limited to this, part or all of the overall control unit 100, the communication unit 101, the neural network control unit 110, and the neural network storage unit 111 may be configured by hardware circuits that operate in cooperation with each other.

The overall control unit 100 controls the overall operation in the neural network distribution server 10. The communication unit 101 controls communication by the communication I/F 1005. The neural network control unit 110 performs control related to the measurement neural network and the execution neural network. The neural network storage unit 111 stores the neural network in the neural network storage device 1006 and reads the neural network stored in the neural network storage device 1006.

In the neural network distribution server 10, the CPU 1000 executes the information processing program for server according to the embodiment to configure each of the overall control unit 100, the communication unit 101, the neural network control unit 110, and the neural network storage unit 111 described above as, for example, a module on a main storage area in the RAM 1002.

The information processing program for server can be acquired from the outside via a communication network such as the Internet by communication via the communication I/F 1005 and installed on the neural network distribution server 10. Not limited to this, the payment application may be provided from the outside via the data I/F 1004. Furthermore, the information processing program for server may be provided by being stored in a detachable storage medium such as a compact disk (CD), a digital versatile disk (DVD), or a universal serial bus (USB) memory.

### (2-2. AI Device)

Configuration examples of the AI devices 20a and 20b as terminal devices of the present disclosure will be described.

FIG. 4 is a block diagram illustrating a configuration of an example of the AI device 20a according to the embodiment. Here, the AI device 20a is illustrated as a device configured as a camera as a whole.

In FIG. 4, the AI device 20a includes a CPU 2000, a ROM 2001, a RAM 2002, a storage device 2003, a data I/F 2004, a communication I/F 2005, and an imaging device 2100, and these units are communicably connected to each other via a bus 2006.

The storage device 2003 is a nonvolatile storage medium such as a flash memory or a hard disk drive. The CPU 2000 controls the entire operation of the AI device 20a by using the RAM 2002 as a work memory according to a program stored in the storage device 2003 or the ROM 2001.

The data I/F 2004 is an interface for transmitting and receiving data to and from an external device. The communication I/F 2005 is an interface for performing communication via the transmission paths 30a and 31, for example.

The neural network distributed from the neural network distribution server 10 via the transmission path 30a is received by the communication I/F 2005, for example, and stored in the RAM 2002 or the storage device 2003. Not limited to this, the neural network may be stored in a memory included in the imaging device 2100 described later.

The imaging device 2100 corresponds to the camera 21 illustrated in FIG. 1, for example, and performs imaging under the control of the CPU 2000, for example. In this example, as will be described later, the imaging device 2100 includes an imaging block for performing imaging, and a signal processing block for performing signal processing on a captured image obtained by imaging by the imaging block.

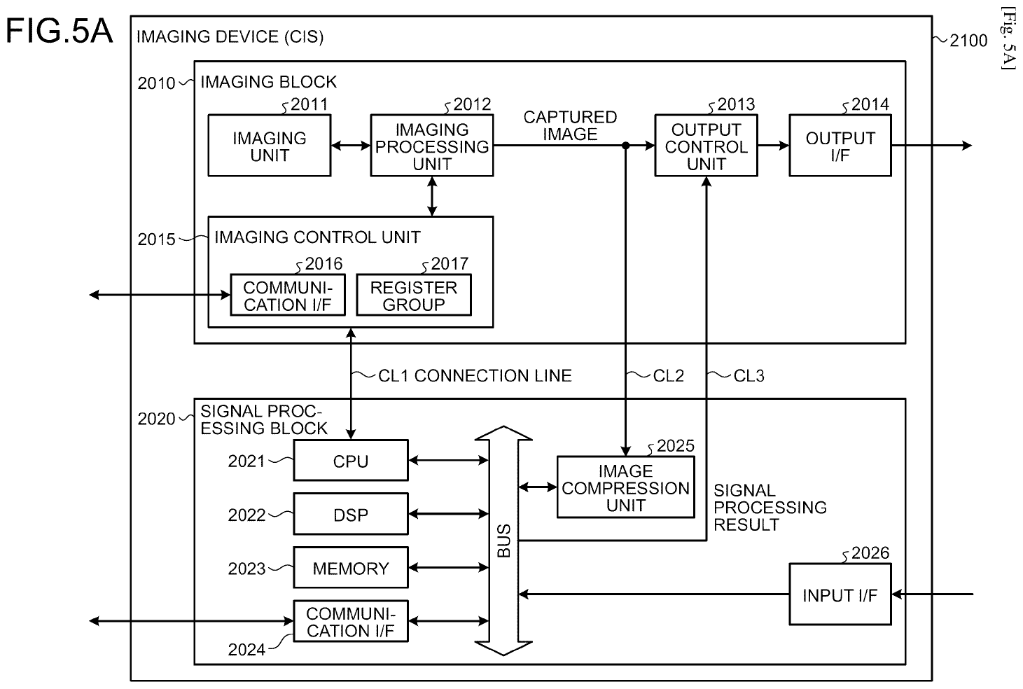

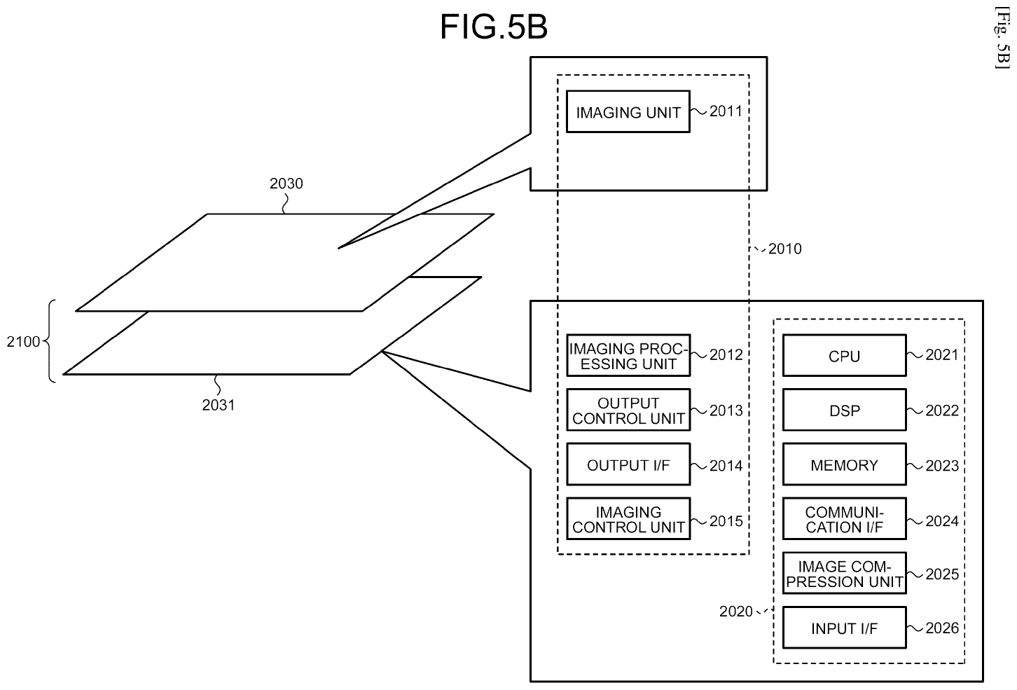

FIG. 5A is a block diagram illustrating a configuration of an example of the imaging device 2100 applicable to the embodiment. In FIG. 5A, the imaging device 2100 is configured as a complementary metal oxide semiconductor (CMOS) image sensor (CIS), and includes an imaging block 2010 and a signal processing block 2020. The imaging block 2010 and the signal processing block 2020 are electrically connected by connection lines CL1, CL2, and CL3 which are internal buses, respectively.

The imaging block 2010 includes an imaging unit 2011, an imaging processing unit 2012, an output control unit 2013, an output I/F 2014, and an imaging control unit 2015, and images a subject to obtain a captured image.

The imaging unit 2011 includes a pixel array in which a plurality of pixels, each of which is a light receiving element that outputs a signal corresponding to light received by photoelectric conversion, is arranged according to a matrix array. The imaging unit 2011 is driven by the imaging processing unit 2012 and images a subject.

That is, light from an optical system which is not illustrated enters the imaging unit 2011. The imaging unit 2011 receives incident light from the optical system in each pixel included in the pixel array, performs photoelectric conversion, and outputs an analog image signal corresponding to the incident light.

The size of the image according to the image signal output from the imaging unit 2011 can be selected from a plurality of sizes such as 3968 pixels×2976 pixels, 1920 pixels×1080 pixels, and 640 pixels×480 pixels in width×height, for example. The image size that can be output by the imaging unit 2011 is not limited to this example. Furthermore, for the image output by the imaging unit 2011, for example, it is possible to select whether to set a color image of red, green, and blue (RGB) or a monochrome image of only luminance. These selections for the imaging unit 2011 can be performed as a type of setting of an imaging mode.

Note that information based on the output of each pixel arranged in a matrix in the pixel array is referred to as a frame. In the imaging device 2100, the imaging unit 2011 repeatedly acquires information of the pixels in a matrix at a predetermined rate (frame rate) in chronological order. The imaging device 2100 collectively outputs the acquired information for each frame.

Under the control of the imaging control unit 2015, the imaging processing unit 2012 performs imaging processing related to imaging of an image in the imaging unit 2011, such as driving of the imaging unit 2011, analog to digital (AD) conversion of an analog image signal output from the imaging unit 2011, and imaging signal processing.

Examples of the imaging signal processing performed by the imaging processing unit 2012 include processing of obtaining brightness for each of predetermined small regions by calculating an average value of pixel values for each of the small regions for an image output from the imaging unit 2011, and HDR conversion processing of converting an image output from the imaging unit 2011 into a high dynamic range (HDR) image, defect correction, development, and the like.

The imaging processing unit 2012 outputs a digital image signal obtained by AD conversion or the like of an analog image signal output from the imaging unit 2011 as a captured image. Furthermore, the imaging processing unit 2012 can also output a RAW image that is not subjected to processing such as development as a captured image. Note that an image in which each pixel has information of each color of RGB obtained by performing processing such as development on the RAW image is referred to as an RGB image.

The captured image output by the imaging processing unit 2012 is supplied to the output control unit 2013 and also supplied to an image compression unit 2025 of the signal processing block 2020 via the connection line CL2.

In addition to the captured image supplied from the imaging processing unit 2012, a signal processing result of signal processing using the captured image and the like is supplied from the signal processing block 2020 to the output control unit 2013 via the connection line CL3.

The output control unit 2013 performs output control of selectively outputting the captured image from the imaging processing unit 2012 and the signal processing result from the signal processing block 2020 from the (one) output I/F 2014 to the outside (for example, a memory connected to the outside of the imaging device 2100 or the like). That is, the output control unit 2013 selects the captured image from the imaging processing unit 2012 or the signal processing result from the signal processing block 2020, and supplies the same to the output I/F 2014.

The output I/F 2014 is an I/F that outputs the captured image and the signal processing result supplied from the output control unit 2013 to the outside. For example, a relatively high-speed parallel I/F such as a mobile industry processor interface (MIPI) can be employed as the output I/F 2014.

In the output I/F 2014, the captured image from the imaging processing unit 2012 or the signal processing result from the signal processing block 2020 is output to the outside according to the output control of the output control unit 2013. Therefore, for example, in a case where only the signal processing result from the signal processing block 2020 is necessary outside and the captured image itself is not necessary, only the signal processing result can be output, and the amount of data output from the output I/F 2014 to the outside can be reduced.

Furthermore, in the signal processing block 2020, signal processing for obtaining a signal processing result needed outside is performed, and the signal processing result is output from the output I/F 2014, so that it is not necessary to perform signal processing outside, and a load on an external block can be reduced.

The imaging control unit 2015 includes a communication I/F 2016 and a register group 2017.

The communication I/F 2016 is, for example, a first communication I/F such as a serial communication I/F such as an inter-integrated circuit (I²C), and exchanges necessary information such as information to be read from and written to the register group 2017 with the outside (for example, a control unit that controls a device on which the imaging device 2100 is mounted).

The register group 2017 includes a plurality of registers and stores imaging information related to imaging of an image by the imaging unit 2011 and various other information. For example, the register group 2017 stores imaging information received from the outside in the communication I/F 2016 and a result (for example, brightness and the like for each small region of the captured image) of the imaging signal processing in the imaging processing unit 2012.

Examples of the imaging information stored in the register group 2017 include (information indicating) ISO sensitivity (analog gain at the time of AD conversion in the imaging processing unit 2012), exposure time (shutter speed), frame rate, focus, imaging mode, cutout range, and the like.

The imaging mode includes, for example, a manual mode in which an exposure time, a frame rate, and the like are manually set, and an automatic mode in which the exposure time, the frame rate, and the like are automatically set according to a scene. Examples of the automatic mode include modes corresponding to various imaging scenes such as a night scene and a person's face.

Furthermore, the clipping range represents a range clipped from an image output by the imaging unit 2011 in a case where a part of the image output by the imaging unit 2011 is clipped and output as a captured image in the imaging processing unit 2012. By specifying the clipping range, for example, only a range in which a person appears can be clipped from the image output by the imaging unit 2011. Note that, as image clipping, there is a method of clipping only an image (signal) in a clipping range from the imaging unit 2011 in addition to a method of clipping from an image output from the imaging unit 2011.

The imaging control unit 2015 controls the imaging processing unit 2012 according to the imaging information stored in the register group 2017, thereby controlling imaging of an image in the imaging unit 2011.

Note that the register group 2017 can store output control information regarding output control in the output control unit 2013 in addition to the imaging information and a result of the imaging signal processing in the imaging processing unit 2012. The output control unit 2013 can perform output control of selectively outputting the captured image and the signal processing result according to the output control information stored in the register group 2017.

Furthermore, in the imaging device 2100, the imaging control unit 2015 and a CPU 2021 of the signal processing block 2020 are connected via the connection line CL1, and the CPU 2021 can read and write information from and to the register group 2017 via the connection line CL1. That is, in the imaging device 2100, reading and writing of information from and to the register group 2017 can be performed not only from the communication I/F 2016 but also from the CPU 2021.

The signal processing block 2020 includes a CPU 2021, a digital signal processor (DSP) 2022, a memory 2023, a communication I/F 2024, the image compression unit 2025, and an input I/F 2026, and performs predetermined signal processing using a captured image or the like obtained by the imaging block 2010. Note that the CPU 2021 is not limited thereto, and may be a micro processor unit (MPU) or a micro controller unit (MCU).

The CPU 2021, the DSP 2022, the memory 2023, the communication I/F 2024, and the input I/F 2026 constituting the signal processing block 2020 are connected to each other via a bus, and can exchange information as necessary.

The CPU 2021 executes a program stored in the memory 2023 to perform control of the signal processing block 2020, reading and writing of information from and to the register group 2017 of the imaging control unit 2015 via the connection line CL1, and other various processes.

For example, by executing the program, the CPU 2021 functions as an imaging information calculation unit that calculates imaging information by using a signal processing result obtained by signal processing in the DSP 2022, and feeds back new imaging information calculated by using the signal processing result to the register group 2017 of the imaging control unit 2015 via the connection line CL1 for storage therein.

Therefore, as a result, the CPU 2021 can control imaging in the imaging unit 2011 and the imaging signal processing in the imaging processing unit 2012 according to the signal processing result of the captured image.

In addition, the imaging information stored in the register group 2017 by the CPU 2021 can be provided (output) to the outside from the communication I/F 2016. For example, the focus information in the imaging information stored in the register group 2017 can be provided from the communication I/F 2016 to a focus driver (not illustrated) that controls the focus.

By executing the program stored in the memory 2023, the DSP 2022 functions as a signal processing unit that performs signal processing using a captured image supplied from the imaging processing unit 2012 to the signal processing block 2020 via the connection line CL2 and information received by the input I/F 2026 from the outside.

The memory 2023 includes a static random access memory (SRAM), a dynamic RAM (DRAM), and the like, and stores data and the like necessary for processing of the signal processing block 2020.

For example, the memory 2023 stores a program received from the outside in the communication I/F 2024, a captured image compressed by the image compression unit 2025 and used in signal processing in the DSP 2022, a signal processing result of the signal processing performed in the DSP 2022, information received by the input I/F 2026, and the like.

The communication I/F 2024 is, for example, a second communication I/F such as a serial communication I/F such as a serial peripheral interface (SPI), and exchanges necessary information such as a program executed by the CPU 2021 or the DSP 2022 with the outside (for example, a memory, a control unit, and the like which are not illustrated).

For example, the communication I/F 2024 downloads a program executed by the CPU 2021 or the DSP 2022 from the outside, supplies the program to the memory 2023, and stores the program. Therefore, various processes can be executed by the CPU 2021 or the DSP 2022 by the program downloaded by the communication I/F 2024.

Note that the communication I/F 2024 can exchange arbitrary data in addition to programs with the outside. For example, the communication I/F 2024 can output the signal processing result obtained by signal processing in the DSP 2022 to the outside. In addition, the communication I/F 2024 outputs information according to an instruction of the CPU 2021 to an external device, whereby the external device can be controlled according to the instruction of the CPU 2021.

Furthermore, the communication I/F 2024 may acquire the neural network distributed from the neural network distribution server 10 and stored in the RAM 2002 or the storage device 2003 by communication with the bus 2006. The neural network acquired by the communication I/F 2024 may be stored in the memory 2023, for example.

The signal processing result obtained by the signal processing in the DSP 2022 can be output from the communication I/F 2024 to the outside and can be written in the register group 2017 of the imaging control unit 2015 by the CPU 2021. The signal processing result written in the register group 2017 can be output from the communication I/F 2016 to the outside. The same applies to the processing result of the processing performed by the CPU 2021.

A captured image is supplied from the imaging processing unit 2012 to the image compression unit 2025 via the connection line CL2. The image compression unit 2025 performs compression processing for compressing the captured image, and generates a compressed image having a smaller data amount than the captured image. The compressed image generated by the image compression unit 2025 is supplied to the memory 2023 via the bus and stored therein.

Here, the signal processing in the DSP 2022 can be performed using not only the captured image itself but also the compressed image generated from the captured image by the image compression unit 2025. Since the compressed image has a smaller amount of data than the captured image, it is possible to reduce the load of signal processing in the DSP 2022 and to save the storage capacity of the memory 2023 that stores the compressed image.

As the compression processing in the image compression unit 2025, for example, scale-down for converting a captured image of 3968 pixels×2976 pixels into an image of 640 pixels×480 pixels can be performed. Furthermore, in a case where the signal processing in the DSP 2022 is performed on luminance and the captured image is an RGB image, YUV conversion for converting the RGB image into, for example, a YUV image can be performed as the compression processing.

Note that the image compression unit 2025 can be implemented by software or can be implemented by dedicated hardware.

The DSP 2022 may further execute the neural network processing by the neural network stored in the memory 2023. Not limited to this, the DSP 2022 may acquire the neural network stored in the RAM 2002 or the storage device 2003 via the communication I/F 2024 and execute the neural network processing.

The input I/F 2026 is an I/F that receives information from the outside. The input I/F 2026 receives, for example, an output (external sensor output) of an external sensor from the external sensor, supplies the external sensor output to the memory 2023 via the bus for storage therein. As the input I/F 2026, for example, a parallel I/F such as an MIPI can be employed similarly to the output I/F 2014.

Furthermore, as the external sensor, for example, a distance sensor that senses information regarding distance can be employed, and moreover, as the external sensor, for example, an image sensor that senses light and outputs an image corresponding to the light, in other words, an image sensor different from the imaging device 2100 can be employed.

In the DSP 2022, in addition to using the captured image or the compressed image generated from the captured image, the signal processing can be performed using the external sensor output received by the input I/F 2026 from the external sensor as described above and stored in the memory 2023.

In the imaging device 2100 configured as described above, the signal processing including the neural network processing using the captured image obtained by imaging by the imaging unit 2011 or the compressed image generated from the captured image is performed by the DSP 2022, and the signal processing result of the signal processing and the captured image are selectively output from the output I/F 2014. Therefore, it is possible to downsize the imaging device that outputs the information needed by the user.

Here, in a case where the signal processing of the DSP 2022 is not performed in the imaging device 2100, and thus the signal processing result is not output from the imaging device 2100 and the captured image is output, that is, in a case where the imaging device 2100 is configured as an image sensor that merely captures and outputs an image, the imaging device 2100 can be configured with only the imaging block 2010 not including the output control unit 2013. In this case, the neural network processing may be executed by the CPU 2000.

FIG. 5B is a perspective view schematically illustrating a structure of an example of the imaging device 2100 applicable to the embodiment described with reference to FIG. 5A.

For example, as illustrated in FIG. 5B, the imaging device 2100 can be configured as a one-chip semiconductor device having a stacked structure in which a plurality of dies is stacked. In the example of FIG. 5B, the imaging device 2100 is configured as a one-chip semiconductor device in which two dies of dies 2030 and 2031 are stacked.

Note that the die refers to a small thin piece of silicon in which an electronic circuit is built, and an individual in which one or more dies are sealed is referred to as a chip.

In FIG. 5B, the imaging unit 2011 is mounted on the upper die 2030. Furthermore, the imaging processing unit 2012, the output control unit 2013, the output I/F 2014, and the imaging control unit 2015 are mounted on the lower die 2031. As described above, in the example of FIG. 5B, the imaging unit 2011 of the imaging block 2010 is mounted on the die 2030, and portions other than the imaging unit 2011 are mounted on the die 2031. The signal processing block 2020 including the CPU 2021, the DSP 2022, the memory 2023, the communication I/F 2024, the image compression unit 2025, and the input I/F 2026 is further mounted on the die 2031.

The upper die 2030 and the lower die 2031 are electrically connected, for example, by forming a through hole that penetrates the die 2030 and reaches the die 2031. Not limited to this, and the dies 2030 and 2031 may be electrically connected by performing metal-metal wiring such as Cu—Cu bonding that directly connects metal wiring of Cu or the like exposed on the lower surface side of the die 2030 and metal wiring of Cu or the like exposed on the upper surface side of the die 2031.

Here, in the imaging processing unit 2012, as a method of performing AD conversion of the image signal output from the imaging unit 2011, for example, a column-parallel AD method or an area AD method can be employed.

In the column-parallel AD method, for example, an AD converter (ADC) is provided for a column of pixels constituting the imaging unit 2011, and the ADC for each column is in charge of AD conversion of pixel signals of the pixels in the column, whereby AD conversion of image signals of the pixels in each column in one row is performed in parallel. In a case where the column-parallel AD method is employed, a part of the imaging processing unit 2012 that performs AD conversion of the column-parallel AD method may be mounted on the upper die 2030.

In the area AD method, pixels constituting the imaging unit 2011 are divided into a plurality of blocks, and an ADC is provided for each block. Then, the ADC for each block is in charge of AD conversion of pixel signals of the pixels in the block, whereby AD conversion of image signals of the pixels in the plurality of blocks is performed in parallel. In the area AD method, AD conversion (reading and AD conversion) of an image signal can be performed only for necessary pixels among pixels constituting the imaging unit 2011 with a block as a minimum unit.

Note that, if the area of the imaging device 2100 is allowed to be large, the imaging device 2100 can be configured with one die.

Furthermore, in the example of FIG. 5B, the one-chip imaging device 2100 is configured by stacking the two dies 2030 and 2031, but the one-chip imaging device 2100 can be configured by stacking three or more dies. For example, in a case where the one-chip imaging device 2100 is configured by stacking three dies, the memory 2023 mounted on the die 2031 in FIG. 5B can be mounted on a die different from the dies 2030 and 2031.

Here, in an imaging device in which chips of a sensor chip, a memory chip, and a DSP chip are connected in parallel by a plurality of bumps (hereinafter also referred to as a bump-connected imaging device), the thickness is greatly increased and the device is increased in size as compared with the one-chip imaging device 2100 configured in a stacked structure.

Furthermore, in the bump-connected imaging device, it may be difficult to secure a sufficient rate as a rate at which a captured image is output from the imaging processing unit 2012 to the output control unit 2013 due to signal deterioration or the like at connection portions of the bumps.

With the imaging device 2100 having a stacked structure, it is possible to prevent the above-described increase in size of the device and the inability to secure a sufficient rate as a rate between the imaging processing unit 2012 and the output control unit 2013. Therefore, with the imaging device 2100 having a stacked structure, it is possible to downsize the imaging device that outputs information needed in processing at the post-stage of the imaging device 2100.

In a case where the information needed in the post-stage is a captured image, the imaging device 2100 can output the captured image (RAW image, RGB image, or the like). Furthermore, in a case where information needed in the post-stage is obtained by signal processing using a captured image, the imaging device 2100 can obtain and output a signal processing result as information needed by the user by performing the signal processing in the DSP 2022.

As the signal processing performed by the imaging device 2100, that is, the signal processing of the DSP 2022, for example, recognition processing of recognizing a predetermined recognition target from a captured image can be employed. The DSP 2022 may execute this recognition processing using the neural network distributed from the neural network distribution server 10.

Furthermore, for example, the imaging device 2100 can receive, by the input I/F 2026, an output of a distance sensor such as a time of flight (ToF) sensor arranged to have a predetermined positional relationship with the imaging device 2100. In this case, as the signal processing of the DSP 2022, for example, fusion processing of integrating the output of the distance sensor and the captured image to obtain an accurate distance, such as processing of removing noise of the distance image obtained from the output of the distance sensor received by the input I/F 2026 using the captured image, can be employed.

Furthermore, for example, the imaging device 2100 can receive an image output by an image sensor arranged to have a predetermined positional relationship with the imaging device 2100 by the input I/F 2026. In this case, as the signal processing of the DSP 2022, for example, self-localization processing (simultaneously localization and mapping (SLAM)) using the image received by the input I/F 2026 and the captured image as stereo images can be employed.

The DSP 2022 may execute the above-described recognition processing, noise removal processing, self-position estimation processing, and the like using the neural network distributed from the neural network distribution server 10.

Note that the imaging device 2100 is not limited to the example configured as the CIS described above, and a general camera configuration, for example, a configuration in which an image is captured by an imaging element and a captured image subjected to predetermined signal processing such as noise removal and level adjustment is output can also be applied. In this case, the CPU 2000 may execute the neural network processing on the captured image.

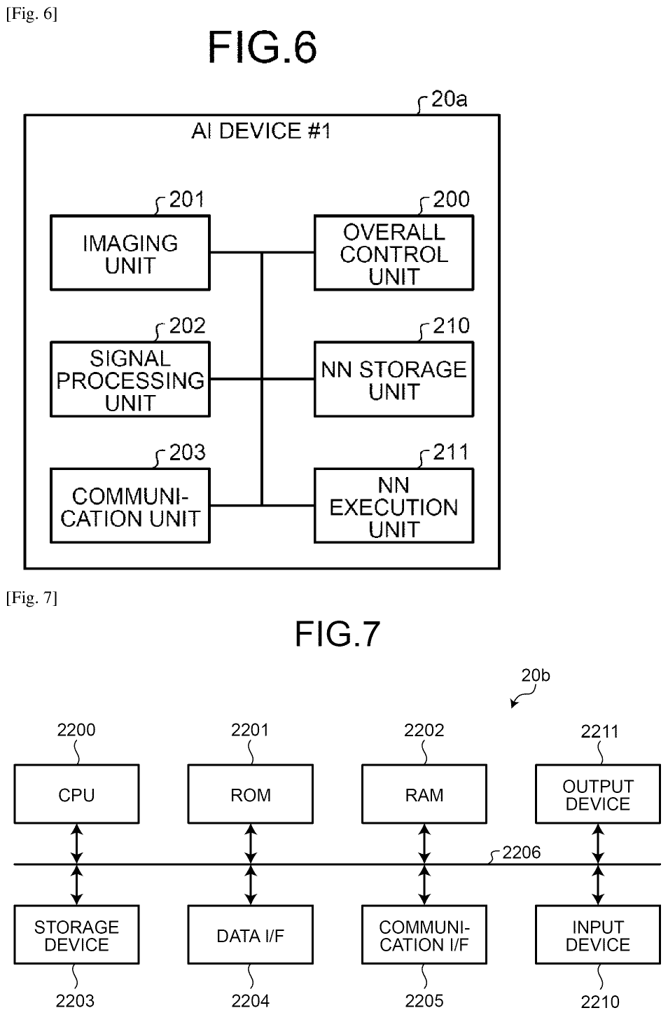

FIG. 6 is a functional block diagram of an example for describing the functions of the AI device 20a according to the embodiment.

In FIG. 6, the AI device 20a includes an overall control unit 200, an imaging unit 201, a signal processing unit 202, a communication unit 203, a neural network storage part 210, and a neural network execution unit 211. Note that, in the drawing, the neural network storage part 210 and the neural network execution unit 211 are illustrated as an NN storage part 210 and an NN execution unit 211, respectively.

The overall control unit 200, the imaging unit 201, the signal processing unit 202, the communication unit 203, the neural network storage part 210, and the neural network execution unit 211 are configured by the operation of a terminal information processing program according to the embodiment on the CPU 2000. Not limited to this, part or all of the overall control unit 200, the imaging unit 201, the signal processing unit 202, the communication unit 203, the neural network storage part 210, and the neural network execution unit 211 may be configured by hardware circuits that operate in cooperation with each other.

The overall control unit 200 controls the overall operation of the AI device 20a. The communication unit 203 controls communication by the communication I/F 2005 in the communication unit 203.

The imaging unit 201 and the signal processing unit 202 control the operation of the imaging device 2100 included in the AI device 20a. More specifically, the imaging unit 201 controls the operation of the imaging block 2010 in the imaging device 2100. Further, the signal processing unit 202 controls the operation of the signal processing block 2020 in the imaging device 2100. Furthermore, the signal processing unit 202 may perform signal processing on a processing result of the neural network processing executed by the neural network execution unit 211.

Note that, in a case where the imaging device 2100 has a general camera configuration, the imaging unit 201 may control an imaging operation by the camera, and the signal processing unit 202 may perform predetermined signal processing on a captured image captured by the camera.

The neural network storage part 210 stores, for example, the neural network distributed from the neural network distribution server 10. The neural network execution unit 211 executes processing by the neural network stored in the neural network storage part 210. Further, the neural network execution unit 211 holds basic parameters indicating the AI processing capability in advance. For example, the basic parameters may be stored in the storage device 2003 or may be included in the terminal information processing program.

In the AI device 20a, the CPU 2000 executes the terminal information processing program according to the embodiment to configure each of the overall control unit 200, the imaging unit 201, the signal processing unit 202, the communication unit 203, the neural network storage part 210, and the neural network execution unit 211 described above as, for example, a module on a main storage area in the RAM 2002.

The terminal information processing program can be acquired from the outside via a communication network such as the Internet by communication via the communication I/F 2005 and installed on the AI device 20a. Not limited to this, the payment application may be provided from the outside via the data I/F 2004. Furthermore, the information processing program for server may be provided by being stored in a detachable storage medium such as a compact disk (CD), a digital versatile disk (DVD), or a universal serial bus (USB) memory.

FIG. 7 is a block diagram illustrating a configuration of an example of the AI device 20b according to the embodiment.

In FIG. 7, the AI device 22b includes a CPU 2200, a ROM 2201, a RAM 2202, a storage device 2203, a data I/F 2204, a communication I/F 2205, an input device 2210, and an output device 2211, and these units are communicably connected to each other via a bus 2206.

The storage device 2203 is a nonvolatile storage medium such as a flash memory or a hard disk drive. The CPU 2200 controls the entire operation of the AI device 22b by using the RAM 2202 as a work memory according to a program stored in the storage device 2203 or the ROM 2201.

The data I/F 2204 is an interface for transmitting and receiving data to and from an external device. The communication I/F 2205 is an interface for performing communication via the transmission paths 30a and 31, for example.

The neural network distributed from the neural network distribution server 10 via the transmission path 30b is received by the communication I/F 2205, for example, and stored in the RAM 2202 or the storage device 2203.

The input device 2210 is for receiving a user operation, and a keyboard, a pointing device such as a mouse, a touch panel, or the like can be applied. The output device 2211 is for presenting information to the user, and a display or a sound output apparatus can be applied.

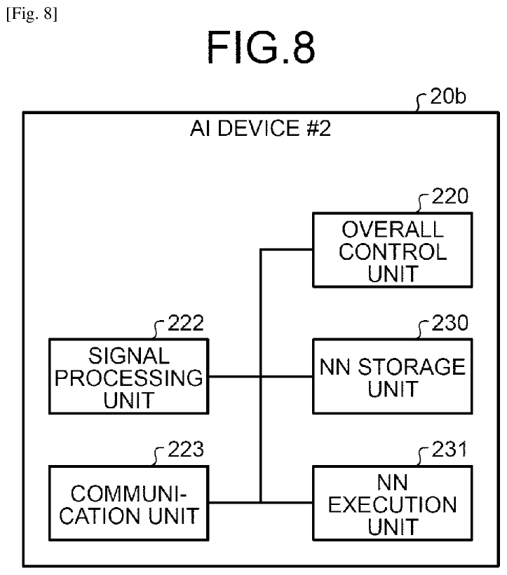

FIG. 8 is a functional block diagram of an example for describing the functions of the AI device 20b according to the embodiment.

As illustrated in FIG. 8, the AI device 20b is obtained by removing the imaging unit 201 from the configuration of the AI device 20a described with reference to FIG. 6. That is, the AI device 20b includes an overall control unit 220, a signal processing unit 222, a communication unit 223, a neural network storage part 230, and a neural network execution unit 231. Note that, in the drawing, the neural network storage part 230 and the neural network execution unit 231 are illustrated as the NN storage part 230 and the NN execution unit 231, respectively.

The functions of the overall control unit 220, the signal processing unit 222, the communication unit 223, the neural network storage part 230, and the neural network execution unit 231 are substantially similar to the respective functions of the overall control unit 200, the signal processing unit 202, the communication unit 203, the neural network storage part 210, and the neural network execution unit 211 in the AI device 20a described with reference to FIG. 6, and thus, description thereof is omitted here. Note that the signal processing unit 222 may perform only the signal processing on a processing result of the neural network processing executed by the neural network execution unit 231, for example.

The overall control unit 220, the signal processing unit 222, the communication unit 223, the neural network storage part 230, and the neural network execution unit 231 are configured by the operation of the terminal information processing program according to the embodiment on the CPU 2200. Note that, in the AI device 20b, execution of the function corresponding to the imaging unit 201 in the terminal information processing program may be omitted.

Note that some or all of the overall control unit 220, the signal processing unit 222, the communication unit 223, the neural network storage part 230, and the neural network execution unit 231 may be configured by hardware circuits that operate in cooperation with each other.

### (3. Existing Technology)

Prior to describing the embodiment in more detail, an existing technique will be described for easy understanding.

As described above, in order to appropriately distribute the neural network, the neural network distribution server 10 needs to know the AI processing capability in a processing device (for example, the AI devices 20a and 20b) that executes the distributed neural network.

As a technology related to acquisition of such AI processing capability, a standard called Network of Intelligent Camera Ecosystem (NICE) has been formulated. The NICE standard relates to a system that can utilize sensor devices of different specifications and user devices of different specifications in a framework, and transmits only data when a predetermined condition is satisfied to a user device side to reduce a load related to data transfer.

As the NICE standard, NICE Data Pipeline Specification v1.0.1 (10.8.2. JSON Object) defines a format of transmission data when a sensor device transmits sensing data (“SceneData”) when a predetermined condition is satisfied. Specifically, in this format, it is specified that “SceneData” as an actual data portion in the sensing data and data called “SceneMark” which is an additional data portion of “SceneData” and includes information of “SceneDataType” indicating a type (kind) of “SceneData” are transmitted.

Further, in the NICE standard, as an application programming interface (API) related to the embodiment, a command GetCapabilities, a command SetSceneMode, a command SetSceneMark, and a command SetSceneData are defined in the above-described NICE Data Pipeline Specification v 1.0.1.

The command GetCapabilities is an API for inquiring the capability of the processing device. With this API, it is possible to acquire information such as whether the processing device can capture a moving image or a still image, a data format of imaging data, and which “SceneMode” the processing device is compatible with. The command SetSceneMode is an API for setting “SceneMode”. “SceneMode” indicates a mode of processing executed by the processing device, such as person detection or moving object detection. The command SetSceneMark is an API for transmitting information at that time when a situation detected by the processing device reaches a trigger set by the command SetSceneMode. For example, in a case where “SceneMode” is set to person detection by the command SetSceneMode, meta information such as a thumbnail image and a time stamp in a case where a person is detected is transmitted by the command SetSceneMark. The command SetSceneData transmits the data itself (“SceneData” described above).

Here, a basic operation sequence when inference using the AI model is executed from the neural network distribution server 10 to the AI devices 20a and 20b in the NICE standard will be described.

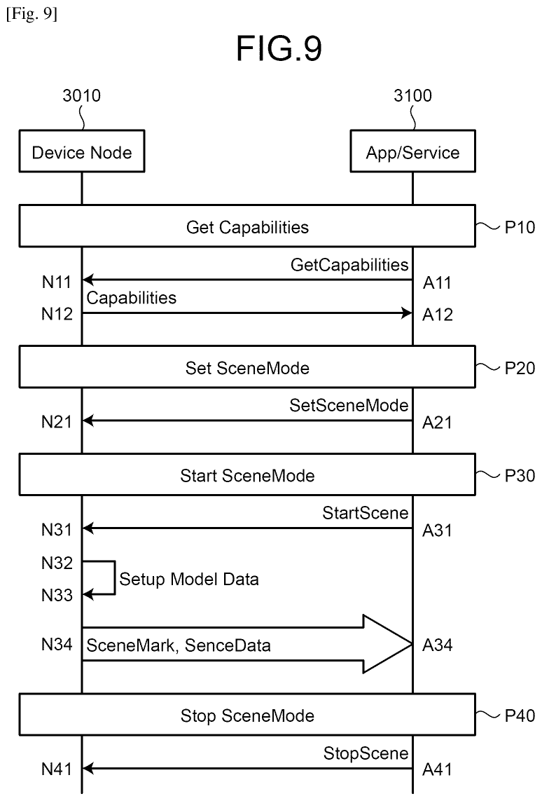

FIG. 9 is a sequence diagram illustrating an example of a basic operation sequence according to the existing technology. In FIG. 9, a node (Device Node) 3010 corresponds to, for example, the AI devices 20a and 20b. Furthermore, an app/service (App/Service) unit 3100 corresponds to, for example, the neural network distribution server 10, and gives an instruction to the node 3010 (for example, the AI device 20a). Note that, although the node 3010 is assumed to be the AI device 20a here, the node 3010 may be the AI device 20b.

As illustrated in FIG. 9, the basic operation includes a capability acquisition phase P10 in which the app/service 3100 acquires the AI processing capability of the device 3000 and/or the node 3010, a mode setting phase P20 in which “SceneMode” is set to the node 3010, an execution phase P30 in which the node 3010 executes the AI processing (neural network processing) for each “SceneMode”, and an end phase P40 in which the node 3010 ends the AI processing.

In the capability acquisition phase P10, first, the app/service 3100 notifies the node 3010 (A11→N11) of an instruction (command GetCapabilities) for reporting the AI processing capability of the device 3000 and/or the node 3010 to the app/service 3100. On the other hand, the node 3010 notifies the app/service 3100 (N12→A12) of information regarding its own AI processing capability (Capabilities).

Note that the information (Capabilities) regarding the AI processing capability of each device 3000 may be managed in advance in the app/service 3100 by performing the capability acquisition phase P10 in advance.

In the mode setting phase P20, the app/service 3100 notifies the node 3010 (A21→N21) of an instruction (command SetSceneMode) as to which “SceneMode” to use.

In the execution phase P30, first, the app/service 3100 notifies the node 3010 (A31→N31) of an instruction (command StartScene) for starting inference using the AI model specified by the command SetSceneMode. On the other hand, on the node 3010 side, setup of reference data designated by “SceneMode” in the mode setting phase P20 is executed (N32→N33). Then, on the node 3010 side, for example, “SceneMark” and “SceneData” are generated using reference data designated by “SceneMode” on the basis of the data acquired by the imaging device 2100, and are transmitted to the app/service 3100 (N34→A34).

In the end phase P40, the app/service 3100 notifies the node 3010 (A41→N41) of an instruction (command StopScene) for ending the inference using the AI model. On the other hand, on the node 3010 side, the inference using the AI model specified in “SceneMode” is terminated.

In the existing technology, it is possible to inquire each processing device about AI processing capability by the command GetCapabilities and determine the dividing position of the neural network on the basis of the result. However, since various elements are related to the AI processing capability, it is extremely difficult to obtain sufficient information regarding distribution of the neural network only by inquiring with the command GetCapabilities.

Thus, in the embodiment of the present disclosure, the neural network distribution server 10 inquires of the AI devices 20a and 20b about the AI processing capability using the command GetCapabilities, and then transmits a neural network for benchmark (measurement neural network) to the AI devices 20a and 20b. The AI devices 20a and 20b measure the processing speed, the hardware margin, and the like using the measurement neural network, and return the measurement results to the neural network distribution server 10. The neural network distribution server 10 can obtain more useful information regarding distribution of the neural network on the basis of the measurement results returned from the AI devices 20a and 20b.

### (4. Embodiment of Present Disclosure)

Next, the embodiment of the present disclosure will be described in more detail.

### (4-1. Flow of Processing According to Embodiment)

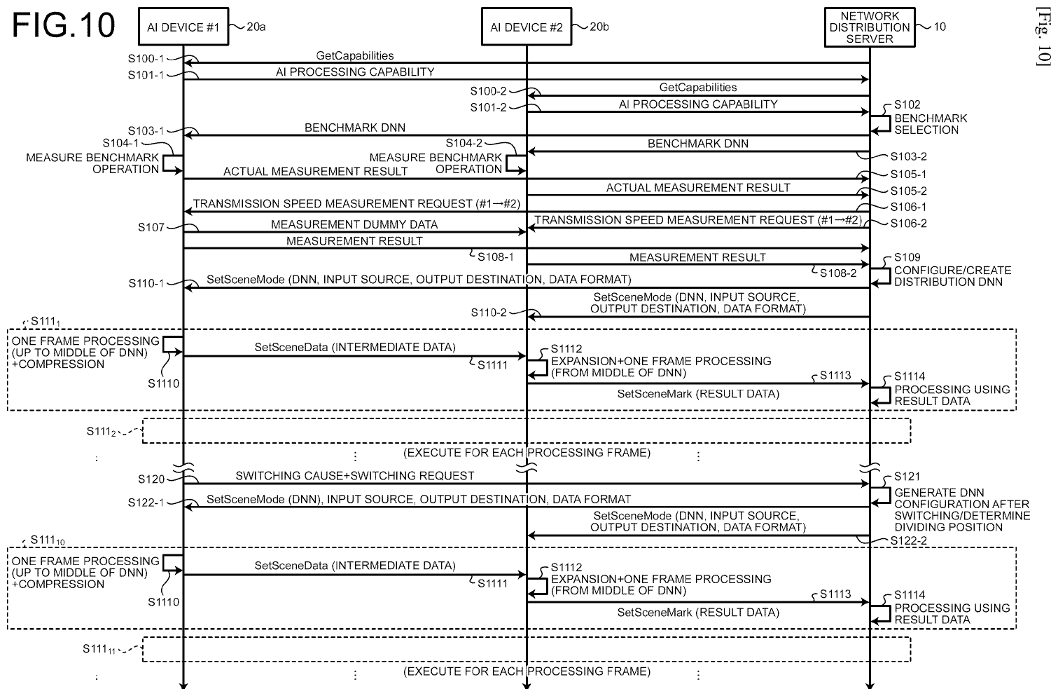

FIG. 10 is a sequence diagram for describing a flow of processing in the information processing system 1 according to the embodiment.

Note that, here, in the information processing system 1, it is assumed that the neural network distribution server 10 divides one deep neural network (DNN) at a predetermined dividing position, and distributes each of the divided neural networks to the two AI devices 20a and 20b. In addition, the AI device 20a executes the neural network processing on the image data acquired by the imaging device 2100 or the like (pre-stage processing), and the AI device 20b executes the neural network processing on the processing result of the AI device 20a (post-stage processing), and transmits the processing result to the neural network distribution server 10.

Note that, hereinafter, each of the divided neural networks obtained by dividing the execution neural network is appropriately referred to as a division execution neural network.

The neural network distribution server 10 transmits the command GetCapabilities to the AI devices 20a and 20b, and inquires about the AI processing capability of each of the AI devices 20a and 202b (steps S100-1 and S100-2). In response to this inquiry, the AI devices 20a and 20b return capability information indicating their own AI processing capability to the neural network distribution server 10 (steps S101-1 and S101-2).

Here, each of the AI devices 20a and 20b may return, for example, seven parameters described in the following (a) to (g) indicating the AI processing capability as the capability information in response to the inquiry by the command GetCapabilities from the neural network distribution server 10. Alternatively, the neural network distribution server 10 may inquire the AI devices 20a and 20b about the parameters of the seven items.
(a) computational power: arithmetic capability available for DNN processing (AI processing). The unit is, for example, floating-point operations per second (FLOPs) or operations per second (OPS).
(b) memory capacity: a memory amount available for DNN processing. This value indicates the upper limit of the size of the neural network that can be held by the AI device. The unit is, for example, a byte.
(c) memory timings: memory access timings available for DNN processing. This is used for access speed calculation.
(d) memory bandwidth: a bandwidth of a memory available for DNN processing. This is used for access speed calculation. The unit is, for example, hertz (Hz).
(c) memory type: an interface type of a memory available for DNN processing. This is used for access speed calculation. Specific examples thereof include double data rate (DDR) 4, DDR5, and the like.
(f) memory channel: an interface type of memory available for DNN processing. This is used for access speed calculation. Specific examples may include dual channel, triple channel, and the like.
(g) HW arch type: architecture of DNN processing arithmetic unit. Specific examples may include Google Edge TPU (registered trademark), Nvidia Volta (registered trademark), Tensilica Vision P6 (registered trademark), and the like.

The neural network distribution server 10 does not necessarily need to acquire information indicating all the AI processing capabilities (a) to (g). The neural network distribution server 10 may acquire at least (a) computational power among the information indicating the AI processing capabilities of (a) to (g).

The neural network distribution server 10 selects a neural network for benchmark (DNN) to be distributed to each of the AI devices 20a and 20b on the basis of the capability information indicating the AI processing capability acquired from each of the AI devices 20a and 20b (step S102).

Although a wide variety of DNNs for benchmark are provided, the neural network distribution server 10 selects an appropriate DNN according to the purpose of the benchmark, the processing capability of the AI device on which the DNN for benchmark is executed acquired by the above-described command GetCapabilities, and the like.

As a DNN for benchmark that can be applied to the embodiment, it is conceivable to apply the following.

In a case where the task executed in the AI device as the benchmark target is object detection and the AI processing capability and memory as a whole of the AI device have a margin, SSD (Single Shot Multibox Detector), YOLO (You Only Look Once) v3, GoogLeNet (registered trademark) Inception V3/V4, Xception, ResNEXT, and the like can be applied as DNNs for benchmark. On the other hand, in a case where the task executed in the AI device as the benchmark target is object detection, and the AI processing capability and the memory as a whole of the AI device are not enough, tiny YOLO v4, tiny YOLO v5, mobilenet v2 ssd, mobilenet v3 ssd, and the like can be applied as the DNN for benchmark.

In a case where the task is classification, AlexNet (registered trademark), GoogLeNet Inception V3/V4, VGGNet (registered trademark), ResNet, SENet, ResNeXt, Xception, MobileNet, and the like can be applied as DNNs for benchmark. Furthermore, in a case where the task is segmentation, SegNet, PSPNet, Decplabv3+, UNet, or the like can be applied as a DNN for benchmark.

Note that it is preferable to use a DNN having a layer structure equivalent to that of the DNN for actual execution as the DNN for benchmark.

Returning to FIG. 10, the neural network distribution server 10 transmits the DNN for benchmark (measurement neural network) selected in step S102 to each of the AI devices 20a and 20b (steps S103-1 and S103-2). Each of the AI devices 20a and 20b executes processing by the DNN for benchmark transmitted from the neural network distribution server 10 and measures the benchmark operation (steps S104-1 and S104-2). Each of the AI devices 20a and 20b transmits an actual measurement result to the neural network distribution server 10 (steps S105-1 and S105-2).

The AI devices 20a and 20b transmit actual measurement results including, for example, the following parameters to the neural network distribution server 10.
Processing time: processing time when one piece of patch data is passed through the DNN. The unit is, for example, seconds (sec). Not limited to this, a processing amount per unit time (how many frames have been processed) such as frame per second (fps) may be used.
Remaining memory: remaining memory available for DNN processing. The unit is, for example, a byte.

Note that the parameters included in the actual measurement results by the benchmark transmitted by the AI devices 20a and 20b are not limited thereto.

Next, the neural network distribution server 10 requests the AI devices 20a and 20b to measure the transmission speed when the processing result is transmitted from the AI device 20a to the AI device 20b via the transmission path 31 (steps S106-1 and S106-2). In response to this request, the AI device 20a transmits measurement dummy data used for measurement of transmission speed to the AI device 20b (step S107). The measurement dummy data is received by the AI device 20b via the transmission path 31. Note that information (data length or the like) of the measurement dummy data may be known in the neural network distribution server 10.

Each of the AI devices 20a and 20b transmits the measurement result of transmission speed using the dummy data to the neural network distribution server 10 (steps S108-1 and S108-2). For example, the AI device 20a transmits the time (transmission start time) when the transmission of the first bit of the dummy data is started and the time (transmission end time) when the last bit of the dummy data is transmitted to the neural network distribution server 10. Further, the AI device 20b transmits the time (reception start time) at which the first bit of the dummy data is received and the time (reception end time) at which the last bit of the dummy data is received to the neural network distribution server 10.

The neural network distribution server 10 obtains, for example, the following parameters on the basis of the measurement results of the transmission speed transmitted from the AI devices 20a and 20b.
Average transfer rate: indicates an average transfer rate, and the unit is, for example, bit per second (bps).
Average latency: indicates an average latency, and a unit is, for example, a byte.

Note that the parameters included in the actual measurement results of the transmission speed transmitted by the AI devices 20a and 20b are not limited thereto.

The neural network distribution server 10 determines the configuration and dividing position of the DNN for actual execution (execution neural network) on the basis of the actual measurement results by the benchmark transmitted from each of the AI devices 20a and 20b in steps S105-1 and S105-2 and the actual measurement results of transmission speed transmitted in steps S108-1 and S108-2, and creates a divided DNN for actual execution (division execution neural network) to be distributed to each of the AI devices 20a and 20b (step S109). A method of determining the dividing position for the DNN for actual execution will be described later.

The neural network distribution server 10 transmits the command SetSceneMode to each of the AI devices 20a and 20b in response to the creation of the divided DNN for actual execution (steps S110-1 and S110-2). The command SetSceneMode transmitted here includes a divided DNN to be executed by the AI device as a transmission destination, information indicating an input source from which data is input to the AI device, information indicating an output destination to which a processing result of the divided DNN by the AI device is output, and information indicating a data format of the processing result to be output.

As a specific example, the neural network distribution server 10 transmits, to the AI device 20a, a command SetSceneMode including a divided DNN that performs prestage processing among created divided DNNs for actual execution, information indicating that the input source is the imaging device 2100, information indicating that the output destination is the AI device 20b, and information indicating a data format. Furthermore, the neural network distribution server 10 transmits, to the AI device 20b, a command SetSceneMode including a divided DNN that performs the post-stage processing among the created divided DNNs for actual execution, information indicating that the input source is the AI device 20a, information indicating that the output destination is, for example, the neural network distribution server 10, and information indicating a data format.

The AI device 20a and the AI device 20b execute processing by the divided DNN for actual execution transmitted from the neural network distribution server 10 for each frame (steps S111₁, S111₂, . . . ). Here, when the input data is image data, the processing for one frame may be processing for one frame of image data.

The processing of steps S111₁, S111₂, . . . will be described as a representative of the processing of step S111₁. In the example of FIG. 10, step S111₁ includes each process of steps S1110 to S1114.

In step S111₁, the AI device 20a executes processing for one frame on the input data by the divided DNN in the pre-stage (step S1110). Here, the processing executed by the AI device 20a is processing up to the middle (dividing position) of the DNN for actual execution. Furthermore, the AI device 20a may perform compression processing on the processing result. The AI device 20a transmits the processing result by the divided DNN in the pre-stage to the AI device 20b as intermediate data of the inference processing by the DNN for actual execution (step S1111).

In step S1112, the AI device 20b executes processing by the divided DNN in the post-stage on the intermediate data for one frame transmitted from the AI device 20a (step S1112). In a case where the intermediate data has been subjected to the compression processing, the AI device 20b executes processing on the intermediate data subjected to expansion processing corresponding to the compression processing. The AI device 20b transmits the processing result by the divided DNN in the post-stage to the neural network distribution server 10 as result data by the inference processing result of the entire original DNN for actual execution by the command SetSceneMark (step S1113).

Note that, in a case where the result data does not include a large amount of data such as image data, the AI device 20b transmits the result data using the command SetSceneMark. On the other hand, in a case where the result data includes image data like segmentation, the AI device 20b transmits the result data using the command SetSceneData. Which of the commands SetSceneMark and SetSceneData is used by the AI device 20b to transmit the result data may be included in the command SetSceneMode by the neural network distribution server 10 in step S110-2 and instructed to the AI device 20b, or may be determined by the AI device 20b itself.

The neural network distribution server 10 may execute processing using the result data, for example, for the result data transmitted as the command SetSceneMark from the AI device 20b (step S1114). Not limited to this, the AI device 20b may transmit the result data to another device that executes processing using the result data.

The processing of steps S111₁, S111₂, . . . is repeatedly executed according to the output of the image data from the imaging device 2100, for example.

During the execution of the processing of steps S111₁, S111₂, . . . , in the AI device 20a or 20b, there may occur a cause in which it is preferable to switch the dividing position with respect to the DNN for actual execution to another position. As such a cause, a cause derived from the remaining battery amount of the AI device 20a or 20b, a cause derived from heat generation of the device, and the like are conceivable.

Since a case where the cause of switching of the dividing position occurs in the AI device 20a and a case where it occurs in the AI device 20b are equivalent processing, a case where the cause of switching of the dividing position occurs in the AI device 20a will be described here.

The AI device 20a transmits a switching request for requesting switching of the dividing position to the neural network distribution server 10 together with the switching cause (step S120). The neural network distribution server 10 determines a new dividing position of the DNN for actual execution according to the switching request and the switching cause transmitted from the AI device 20a, and generates a configuration after switching. The neural network distribution server 10 divides the DNN for actual execution at the dividing position according to the generated configuration after switching, and creates an updated divided DNN for actual execution (step S121).

At this time, the neural network distribution server 10 determines a new dividing position of the DNN for actual execution from each of the AI devices 20a and 20b using the AI processing capability acquired in steps S101-1 and S101-2, the actual measurement result of the DNN for benchmark acquired in steps S105-1 and S105-2, and the measurement result of transmission speed acquired in steps S108-1 and S108-2.

The neural network distribution server 10 transmits a command GetSceneMode including the divided DNN for the pre-stage processing among the updated divided DNN for actual execution to the AI device 20a (step S122-1). Similarly, the neural network distribution server 10 transmits a command GetSceneMode including a divided DNN for post-stage processing among the updated divided DNN for actual execution to the AI device 20b (step S122-2).

The command GetSceneMode transmitted in steps S122-1 and S122-2 includes information indicating an input source of data, information indicating an output destination of a processing result, and information indicating a data format of the processing result together with the divided DNN, similarly to the command SetSceneMode described in step S110-1 and the like.

The AI devices 20a and 20b that have received the command GetSceneMode transmitted in steps S122-1 and S122-2 execute processing by the divided DNN included in the command GetSceneMode for each frame (steps S111₁₀, S111₁₁, . . . ). Since the processing in steps S111₁₀, S111₁₁, . . . is similar to the processing in steps S111₁, S111₂, . . . ) described above, the description thereof will be omitted here.

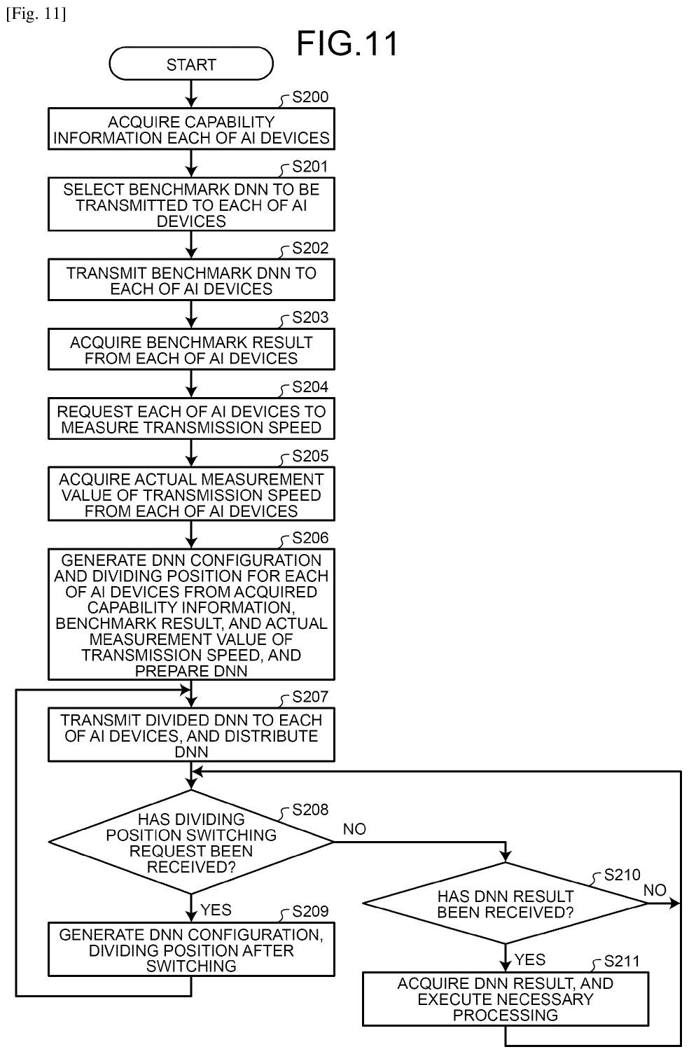

FIG. 11 is a flowchart of an example for describing processing in the neural network distribution server 10 according to the embodiment.

In step S200, the neural network distribution server 10 acquires the capability information indicating the processing capability regarding the AI processing of each of the AI devices 20a and 20b by the neural network control unit 110 using the command GetCapabilities.

In the next step S201, the neural network control unit 110 selects a DNN for benchmark to be transmitted to each of the AI devices 20a and 20b on the basis of the capability information of each of the AI devices 20a and 20b acquired in step S200 and the like. Note that the DNN for benchmark is assumed to be stored in advance in the neural network storage unit 111, for example. In the next step S202, the neural network control unit 110 transmits the DNN for benchmark selected in step S201 to each of the AI devices 20a and 20b. In the next step S203, the neural network distribution server 10 acquires the benchmark result obtained by executing the processing by the DNN for benchmark from each of the AI devices 20a and 20b.

In the next step S204, the neural network control unit 110 requests each of the AI devices 20a and 20b to measure the transmission speed. In the next step S205, the neural network distribution server 10 acquires an actual measurement value obtained by measuring the transmission speed from each of the AI devices 20a and 20b.

In the next step S206, the neural network control unit 110 generates the divided DNN configuration for actual execution and the dividing position for the DNN for actual execution to be applied to each of the AI devices 20a and 20b on the basis of the capability information, the benchmark result, and the actual measurement value of the transmission speed acquired in steps S200, S203, and S205, respectively, from each of the AI devices 20a and 20b. The neural network control unit 110 divides the DNN for actual execution stored in the neural network storage unit 111 according to the generated divided DNN configuration and dividing position, and creates and prepares a divided DNN for actual execution to be distributed to each of the AI devices 20a and 20b.

In the next step S207, the neural network control unit 110 transmits the divided DNN for actual execution prepared in step S206 to each of the AI devices 20a and 20b using the command SetSceneMode, and distributes the DNN for actual execution to each of the AI devices 20a and 20b.

In the next step S208, the neural network control unit 110 determines whether or not the switching request for the dividing position of the DNN has been received from at least one of the AI device 20a or 20b. When the neural network control unit 110 receives the switching request for the dividing position of the DNN (step S208, “Yes”), the process is advanced to step S209.

In step S209, the neural network control unit 110 generates the configuration after the switching in response to the switching request received in step S208, and determines a new dividing position of the DNN for actual execution. After the processing of step S209, the neural network control unit 110 returns the processing to step S207, and transmits the divided DNN obtained by dividing the DNN for actual execution at the new dividing position to each of the AI devices 20a and 20b.

On the other hand, when the neural network control unit 110 determines that the switching request is not received in step S208 (step S208, “No”), the process is advanced to step S210. In step S210, the neural network control unit 110 determines whether a DNN processing result has been received from the AI device 20b that executes processing by the divided DNN in the post-stage. When the neural network control unit 110 determines that the reception has not been performed (step S210, “No”), the processing returns to step S208.

On the other hand, when the neural network control unit 110 determines that the DNN processing result has been received from the AI device 20b in step S210 (step S210, “Yes”), the process is advanced to step S211. In step S211, the neural network control unit 110 acquires the DNN processing result received from the AI device 20b, and executes necessary processing according to the acquired processing result. After the processing of step S211, the neural network control unit 110 advances the process to step S208.

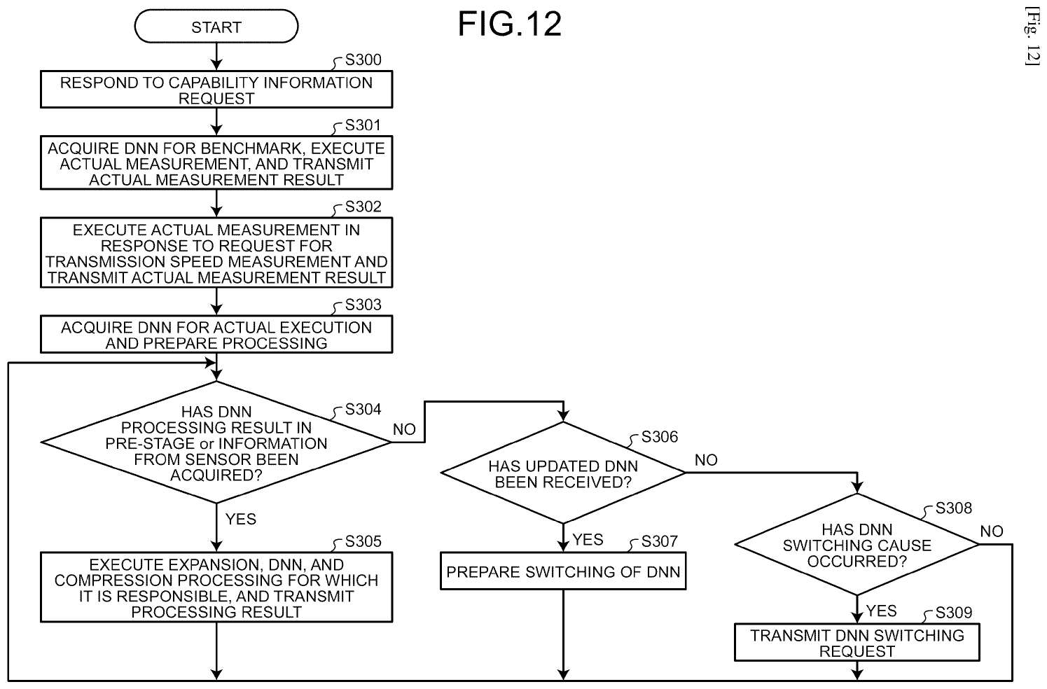

FIG. 12 is a flowchart of an example for describing processing in the AI devices 20a and 20b according to the embodiment. Note that since processing in the AI devices 20a and 20b is substantially common, processing by the AI device 20a will be described unless otherwise specified.

In step S300, the AI device 20a responds to the capability information using the command GetCapabilities transmitted from the neural network distribution server 10 by the neural network execution unit 211, and transmits the capability information indicating its own AI processing capability to the neural network distribution server 10.

In the next step S301, the neural network execution unit 211 acquires the DNN for benchmark transmitted from the neural network distribution server 10. The neural network execution unit 211 executes processing by the acquired DNN for benchmark, and measures the benchmark operation. The neural network execution unit 211 transmits the actual measurement result to the neural network distribution server 10.

In the next step S302, the neural network execution unit 211 executes actual measurement of transmission speed by the transmission path 31 in response to a transmission speed measurement request from the neural network distribution server 10, and transmits the actual measurement result to the neural network distribution server 10.

Here, in the AI device 20a, the neural network execution unit 211 transmits measurement dummy data used for measurement of transmission speed to the AI device 20b, and transmits information regarding transmission of the dummy data (for example, the transmission start time and the transmission end time described above) to the neural network distribution server 10 as an actual measurement result. On the other hand, in the AI device 20b, the neural network execution unit 231 receives the dummy data transmitted from the AI device 20a, and transmits information regarding reception of the dummy data (for example, the reception start time and the reception end time described above) to the neural network distribution server 10 as an actual measurement result.

In the next step S303, the neural network execution unit 211 acquires the DNN for actual execution transmitted from the neural network distribution server 10, and prepares processing by the acquired DNN. Note that the DNN for actual execution acquired in step S303 is a divided DNN obtained by dividing the original DNN for actual execution at the dividing position by the neural network distribution server 10.

In the next step S304, the neural network execution unit 211 determines whether or not a processing result of the DNN processing in the pre-stage or information from a sensor (for example, the imaging device 2100) has been acquired. Note that, in step S304, in a case where the AI device including the neural network execution unit 211 itself is the AI device 20a that performs the pre-stage processing of the DNN, the neural network execution unit 211 determines whether or not the information from the sensor has been acquired. On the other hand, in a case where the AI device including the neural network execution unit 211 itself is the AI device 20b that performs the post-stage processing of the DNN, the neural network execution unit 211 determines whether or not the processing result from the AI device 20a has been acquired.

When the neural network execution unit 211 determines that the information from the pre-stage or the sensor is acquired in step S304 (step S304, “Yes”), the process is advanced to step S305. In step S305, the neural network execution unit 211 executes expansion processing, DNN processing, and compression processing for the portion for which the AI device including itself is responsible, and outputs processing results.

For example, in a case where the AI device 20 is the AI device 20a that performs the pre-stage processing, the neural network execution unit 211 executes the processing by the divided DNN on the information acquired from the sensor. The neural network execution unit 211 performs compression processing on the processing result and transmits the processing result to the AI device 20b that performs the post-stage processing. Furthermore, for example, in a case where the AI device is the AI device 20b that performs the post-stage processing, the neural network execution unit 211 performs expansion processing on the DNN processing result transmitted from the AI device 20a, and executes processing by the divided DNN on the expanded DNN processing result. The neural network execution unit 211 transmits the processing result to, for example, the neural network distribution server 10.

After the processing of step S305, the neural network execution unit 211 advances the process to step S304.

On the other hand, when the neural network execution unit 211 determines that the information from the pre-stage or the sensor is not acquired in step S304 (step S304, “No”), the process is advanced to step S306.

In step S306, the neural network execution unit 211 determines whether the updated divided DNN has been received from the neural network distribution server 10. When the neural network execution unit 211 determines that the updated divided DNN is received (step S306, “Yes”), the process is advanced to step S307. In step S307, the neural network execution unit 211 acquires the updated divided DNN transmitted from the neural network distribution server 10, and prepares processing by the acquired divided DNN.

After the processing of step S307, the neural network execution unit 211 advances the process to step S304.

On the other hand, when the neural network execution unit 211 determines that the updated divided DNN is not received from the neural network distribution server 10 in step S306 (step S306, “No”), the process is advanced to step S308.

In step S308, the neural network execution unit 211 determines whether or not a cause that it is preferable to switch the dividing position for the DNN for actual execution to another position has occurred. When the neural network execution unit 211 determines that the cause has occurred (step S308, “Yes”), the process is advanced to step S309. In step S309, the neural network execution unit 211 transmits a switching request for requesting switching of the dividing position to the neural network distribution server 10 together with the switching cause.

After the processing of step S309, the neural network execution unit 211 advances the process to step S304.

On the other hand, when the neural network execution unit 211 determines in step S308 that the cause that it is preferable to switch the dividing position for the DNN for actual execution to another position has not occurred (step S308, “No”), the process is advanced to step S304.

As described above, in the information processing system 1 according to the embodiment, when the execution neural network (neural network for actual execution) is divided at the dividing positions and each of the divided neural networks is distributed to each AI device, the dividing position of the execution neural network is determined on the basis of the AI capability information of each AI device and the actual measurement values of the benchmark operation and the transmission speed actually measured by each AI device. Therefore, by applying the information processing system 1 according to the embodiment, the execution neural network can be divided at more appropriate dividing positions and distributed to each AI device.

### (4-2. Method of Determining Neural Network Dividing Position According to Embodiment)

Next, a method of determining the dividing position of the execution neural network in steps S109 and S121 described with reference to FIG. 10 and step S206 described with reference to FIG. 11 will be described more specifically.

In the embodiment, the dividing position of the execution neural network is determined according to the following procedures (1) to (5). Note that, in the following, it is assumed that the execution neural network is divided into two at the dividing position, and each of the divided pieces is distributed to the AI device #1 and the AI device #2.
(1) The processing amount when data passes through each of layers (respective layers) of the measurement neural network is listed.
(2) Data communication amounts between the respective layers are listed.
(3) The distribution of the processing amount to the AI devices #1 and #2 and the data communication amount in a case where the dividing position is set between respective layers are obtained.
(4) The processing speed is calculated from the processing speed of each of the AI devices #1 and #2 with respect to each processing amount distribution between the respective layers and the transmission speed with respect to the data communication amount, and the strictest value among the three values (the processing speed of the AI device #1, the processing speed of the AI device #2, and the transmission speed) is set as the processing speed. In this case, in a case of a system that compresses a processing result and performs transmission, each numerical value is calculated in consideration of compression/expansion processing and an average compression rate.
(5) The dividing position of the execution neural network is determined by evaluating at which position for the dividing between the respective layers the performance of the system is the highest.

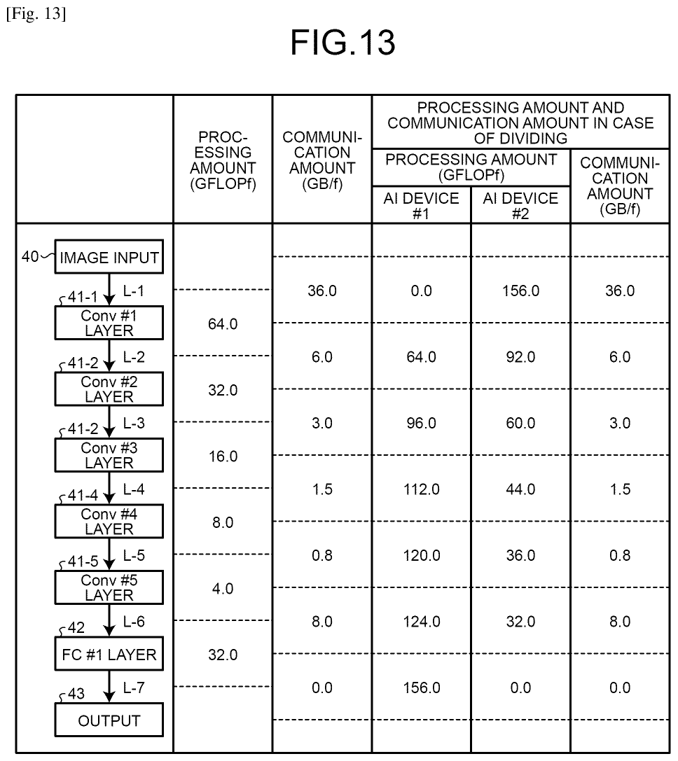

FIG. 13 is a schematic diagram for describing the processing amount of each layer, the data communication amount between respective layers, and the distribution of the processing amount to each AI device according to the embodiment. The processing of (1) to (3) described above will be described with reference to FIG. 13. Here, each processing amount and each data communication amount are values that can be theoretically calculated from the neural network configuration of the execution neural network.

Here, as illustrated in a left end frame of FIG. 13, the measurement neural network and the execution neural network are assumed to have eight layers of an input layer 40 to which an image is input, five convolution layers 41-1 to 41-5 that each perform convolution processing on input data, one fully connected layer 42, and an output layer 43.

Note that, in FIG. 13, the convolution layers 41-1 to 41-5 are also illustrated as Conv #1 layers to Conv #5 layers, respectively. Similarly, the fully connected layer 42 is also designated as FC layer #1. Furthermore, respective adjacent layers from the input layer 40 to the output layer 43 are also indicated as respective adjacent layers L-1 to L-7. Furthermore, the unit of the processing amount is GFLOPf (Giga Floating-point number Operations Per frame), and the unit of the communication amount is GB/f (Giga Bytes per frame).

In the example of FIG. 13, as indicated in the “processing amount” column, the processing amounts of the convolution layers 41-1 to 41-5 and the fully connected layer 42 are calculated respectively as 64.0, 32.0, 16.0, 8.0, 4.0, and 32.0 on the basis of the processing of the measurement neural network (the above-described processing (1)). Further, as indicated in the “communication amount” column, the communication amounts between respective adjacent layers L-1 to L-7 are calculated as 36.0, 6.0, 3.0, 1.5, 0.8, 8.0, and 0.0, respectively, on the basis of the processing of the measurement neural network (the processing (2) described above). The processing amounts and the communication amounts illustrated in FIG. 13 are calculated as values when the AI device #1, the AI device #2, and the transmission path 31 are operated at the maximum speed.

The right column of FIG. 13 illustrates the processing amount distribution and the communication amount of each of the AI devices #1 and #2 in a case of dividing the measurement neural network by the respective adjacent layers L-1 to L-7 (the above-described processing (3)). In other words, the right side column of FIG. 13 illustrates the distribution of the first processing amount of the AI device #1 and the second processing amount of the AI device #2 and the communication amount in a case where each of the adjacent layers L-1 to L-7 is set as a possible dividing position for performing the division.

Specifically, the processing amount distribution of the AI devices #1 and #2 is 0.0 to 156.0 in the case of division between the adjacent layers L-1, 64.0 to 92.0 in the case of division between the adjacent layers L-2, 96.0 to 60.0 in the case of division between the adjacent layers L-3, 112.0 to 44.0 in the case of division between the adjacent layers L-4, 120.0 to 36.0 in the case of division between the adjacent layers L5, 124.0 to 32.0 in the case of division between the adjacent layers L-6, and 156.0 to 0.0 in the case of division between the adjacent layers L-7. In addition, the communication amount is the same as the value in the left field.

Each numerical value illustrated in FIG. 13 is for the purpose of description, and is not limited to this numerical value.

Next, processing for determining the dividing position of the execution neural network according to the embodiment will be described more specifically. In the embodiment, the dividing position is determined by giving priority to any one of (A) the processing speed of the entire neural network, (B) the power consumption in the entire neural network, and (C) the transmission speed when the processing result is transmitted from the AI device #1 to the AI device #2.

### (A: Processing Speed Priority Case)

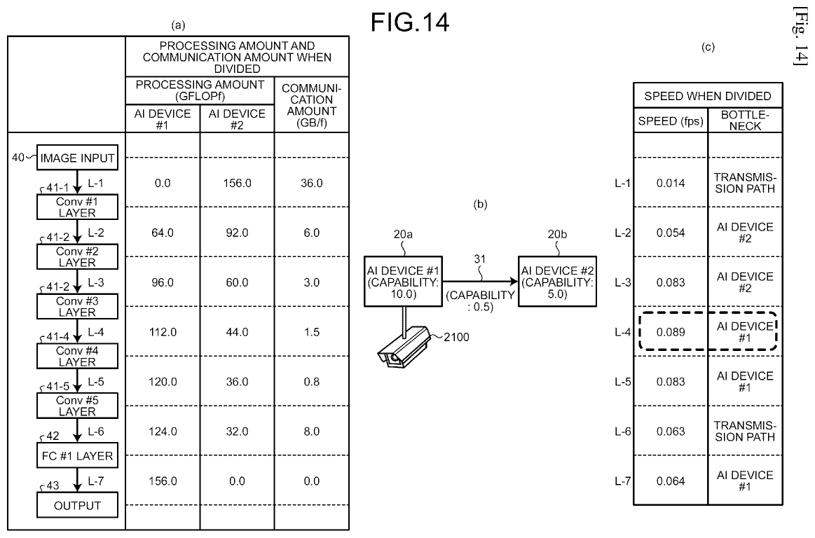

First, (A) a case where the dividing position is determined by giving priority to the processing speed of the entire neural network will be described. FIG. 14 is a schematic diagram for describing the determination processing of the dividing position based on the processing speed of the entire neural network according to the embodiment. In FIG. 14, the configurations of the execution neural network and the measurement neural network are the same as the configurations illustrated in the left frame of FIG. 13, and the processing amount in each layer and the communication amount between the respective layers are also the same as the values illustrated in the left column of FIG. 13.

In FIG. 14, section (a) is the same as the neural network configuration of the left end frame of FIG. 13, the processing amount distribution of the AI devices #1 and #2 in the right column of FIG. 13, and the communication amount between the respective layers.

Section (b) of FIG. 14 illustrates models by the AI device #1 (AI device 20a) and the AI device #2 (AI device 20b) in a case where the dividing position is determined by giving priority to the processing speed. In this model, the AI devices #1 and #2 are actually measured with the capability values of 10.0 (GFLOPs (Giga Floating point number Operations Per second)) and 5.0 (GFLOPs), respectively. The neural network distribution server 10 may acquire the capability values of the AI device #1 and the AI device #2 on the basis of, for example, the actual measurement results by the DNN for benchmark in steps S103-1 to S105-2 of FIG. 10.

In addition, in section (b) of FIG. 14, the transmission path 31 has a capability value of 0.5 (GB/s (Giga Bit per second)). The neural network distribution server 10 may acquire the capability value of the transmission path 31 on the basis of, for example, the measurement results of the transmission speed in steps S106-1 to S108-2 of FIG. 10.

Furthermore, section (c) of FIG. 14 illustrates an example of the processing speed (fps) in a case where the neural network is divided between the respective layers.

For example, in the neural network distribution server 10, the neural network control unit 110 obtains the processing time for each of the AI devices #1 and #2 on the basis of the capability value and the processing amount in the right column. Further, the neural network control unit 110 obtains the processing time for the transmission path 31 on the basis of the capability value and the communication amount in the right field. That is, three processing times are obtained between the respective layers. In each case of dividing between the respective layers, the neural network control unit 110 determines the processing speed at a bottleneck with the item having the largest processing time as the bottleneck.

Specifically, in the example of FIG. 14, the processing times of the AI device #1, the AI device #2, and the communication amount in a case of dividing by the respective adjacent layers L-1 to L-7 are calculated in the respective adjacent layers L-1 to L-7 as follows on the basis of the respective values in section (a) and the respective capability values of the AI devices #1 and #2 and the transmission path 31.
L-1: AI device #1=0, AI device #2=31.2, communication amount=72
L-2: AI device #1=6.4, AI device #2=18.4, communication amount=12
L-3: AI device #1=9.6, AI device #2=12, communication amount=6
L-4: AI device #1=11.2, AI device #2=8.8, communication amount=5
L-5: AI device #1=12, AI device #2=7.2, communication amount=1.6
L-6: AI device #1=12.4, AI device #2=6.4, communication amount=16
L-7: AI device #1=15.6, AI device #2=0, communication amount=0

Therefore, the bottleneck of each of the respective adjacent layers L-1 to L-7 is as follows with reference to section (c) of FIG. 14.

$$Adjacent layers L - 1 = transmission path$$

$$Adjacent layers L - 2 = AI device \#2$$

$$Adjacent layers L - 3 = AI device \#2$$

$$Adjacent layers L - 4 = AI device \#1$$

$$Adjacent layers L - 5 = AI device \#1$$

$$Adjacent layers L - 6 = transmission path$$

$$Adjacent layers L - 7 = AI device \#2$$

In the respective adjacent layers L-1 to L-7, the processing speed at the bottleneck is calculated as follows with reference to section (c) of FIG. 14.

$$Adjacent layers L - 1 = 0.014 ( fps )$$

$$Adjacent layers L - 2 = 0.054 ( fps )$$

$$Adjacent layers L - 3 = 0.083 ( fps )$$

$$Adjacent layers L - 4 = 0.089 ( fps )$$

$$Adjacent layers L - 5 = 0.083 ( fps )$$

$$Adjacent layers L - 6 = 0.063 ( fps )$$

$$Adjacent layers L - 7 = 0.064 ( fps )$$

The neural network control unit 110 determines the adjacent layers with the highest processing speed at the bottleneck among the respective adjacent layers L-1 to L-7 as the dividing position. In the example in section (c) of FIG. 14, since the processing speed of the adjacent layers L-4 is the largest value (0.089 fps), the neural network control unit 110 determines the adjacent layers L-4 as the dividing position.

### (B: Case of Giving Priority to Power Consumption)

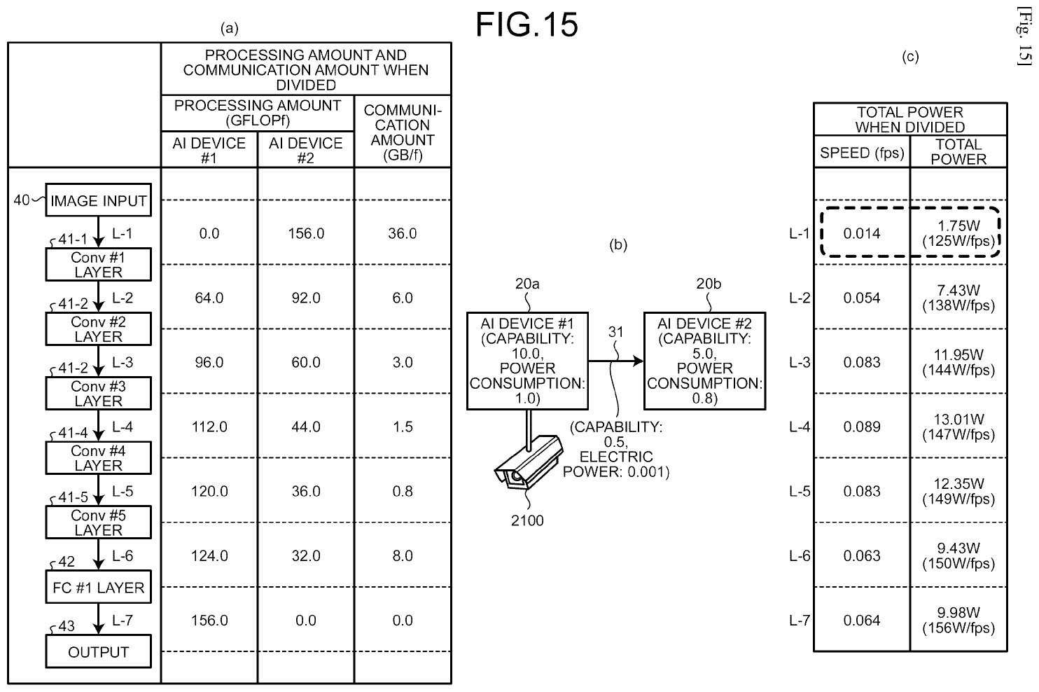

Next, (B) a case where the dividing position is determined by giving priority to power consumption of the entire neural network will be described. FIG. 15 is a schematic diagram for describing determination processing of a dividing position based on power consumption of the entire neural network according to the embodiment.

Note that, in FIG. 15, the configurations of the execution neural network and the measurement neural network are the same as the configurations illustrated in the left frame of FIG. 13, and the processing amounts and the communication amounts are also the same as the values illustrated in the left column of FIG. 13. Furthermore, in FIG. 15, section (a) is common to section (a) of FIG. 14 described above, and thus description thereof is omitted here.

Section (b) of FIG. 15 illustrates models by the AI device #1 (AI device 20a) and the AI device #2 (AI device 20b) in a case where the dividing position is determined by giving priority to the power consumption. Furthermore, FIG. 15 section (c) illustrates an example of the processing speed (fps) and the overall power consumption (total power) in a case where the neural network is divided between the respective adjacent layers. In section (c), the processing speed of the left column is the same as the processing speed of section (c) of FIG. 14.

In section (b) of FIG. 15, in the AI devices #1 and #2, the capability values are 10.0 (GFLOPs) and 5.0 (GFLOPs), respectively, and the power consumption is 1.0 and 0.8. The unit of the power consumption in this case is W (watt)/(GFLOPs).

The neural network distribution server 10 may acquire power consumption of the AI device #1 and the AI device #2 from the AI device #1 and the AI device #2 by the commands GetCapabilities in steps S100-1 and S100-2 of FIG. 10, for example. Not limited to this, the power consumption of the AI device #1 and the AI device #2 may be known in the neural network distribution server 10, for example, or may be acquired on the basis of the actual measurement result by the DNN for benchmark as in the processing in steps S103-1 to S105-2 in FIG. 10.

In addition, in section (b) of FIG. 15, the transmission path 31 has a capability value of 0.5 (GB/s) and power consumption of 0.001. The unit of the power consumption in this case is W/(GB/s).

The neural network distribution server 10 may acquire these capability values from each of the AI devices #1 and #2 by, for example, the commands GetCapabilities in steps S100-1 and S100-2 of FIG. 10. Not limited to this, the power consumption of the transmission path 31 may be known in the neural network distribution server 10, for example, or may be acquired as in the processing in steps S106-1 to S108-2 in FIG. 10, for example.

Furthermore, section (c) of FIG. 15 illustrates an example of the overall power consumption (total power) in a case where the neural network is divided between the respective adjacent layers.

For example, in the neural network distribution server 10, the neural network control unit 110 calculates the processing speed of the AI devices #1 and #2 and the transmission path 31 in a similar manner to the above. Further, the neural network control unit 110 calculates the power consumption of each of the AI devices #1 and #2 with respect to each processing amount distribution and the power consumption based on the transmission speed with respect to the communication amount, and sets the sum of these three power consumption as the total power.

Specifically, in the example of FIG. 15, the power consumption per unit time by the AI device #1, the AI device #2, and the transmission path 31 in the case of dividing by the respective adjacent layers L-1 to L-7 is calculated in the respective adjacent layers L-1 to L-7 as follows on the basis of the respective values in section (a) and the respective capability values and power consumption of the AI device #1, the AI device #2, and the transmission path 31.

$$Adjacent layers L - 1 = 125 ( W / fps )$$

$$Adjacent layers L - 2 = 138 ( W / fps )$$

$$Adjacent layers L - 3 = 144 ( W / fps )$$

$$Adjacent layers L - 4 = 147 ( W / fps )$$

$$Adjacent layers L - 5 = 149 ( W / fps )$$

$$Adjacent layers L - 6 = 150 ( W / fps )$$

$$Adjacent layers L - 7 = 156 ( W / fps )$$

On the basis of these values and the processing speed in the case of dividing by the respective adjacent layers L-1 to L-7, the total power in the case of division by the respective adjacent layers L-1 to L-7 is calculated as follows.

$$Adjacent layers L - 1 = 1.75 ( W )$$

$$Adjacent layers L - 2 = 7.43 ( W )$$

$$Adjacent layers L - 3 = 11.95 ( W )$$

$$Adjacent layers L - 4 = 13.01 ( W )$$

$$Adjacent layers L - 5 = 12.35 ( W )$$

$$Adjacent layers L - 6 = 9.43 ( W )$$

$$Adjacent layers L - 7 = 9.98 ( W )$$

Among these respective adjacent layers L-1 to L-7, the neural network control unit 110 determines the adjacent layers with the smallest total power as the dividing position. In the example in section (c) of FIG. 15, since the total power of the adjacent layers L-1 is the smallest value (1.75 (W)), the neural network control unit 110 determines the adjacent layers L-1 as the dividing position.

### (C: Case of Transmission Speed)

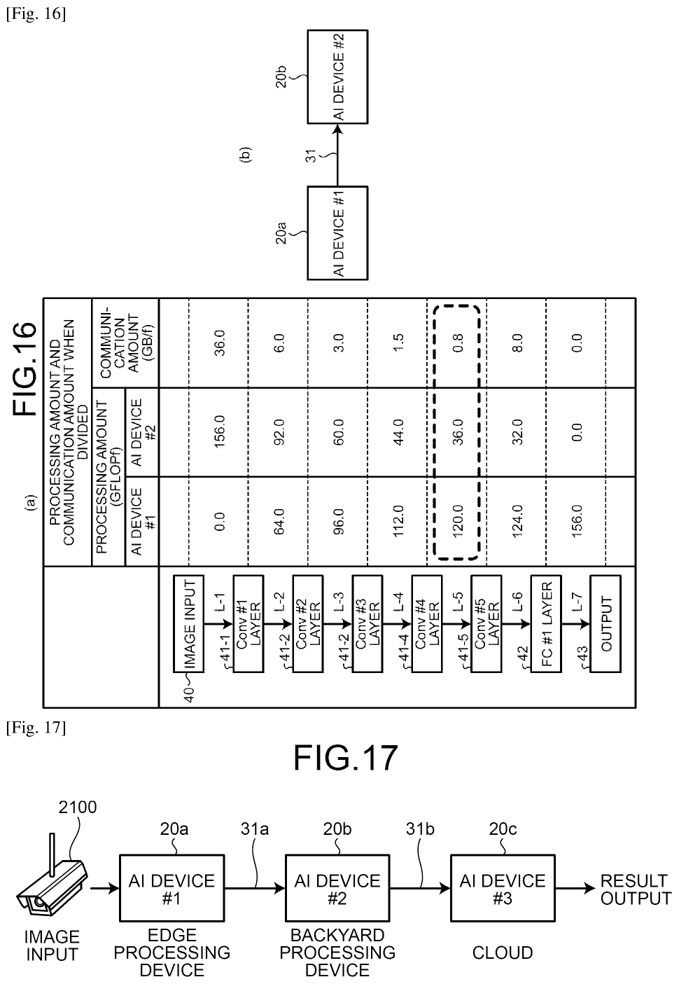

Next, (C) a case where the dividing position is determined by giving priority to the transmission speed when the processing result is transmitted from the AI device #1 to the AI device #2 will be described. FIG. 16 is a schematic diagram for describing dividing position determination processing based on the transmission speed in the transmission path 31 according to the embodiment.

Note that, in FIG. 16, the configurations of the execution neural network and the measurement neural network are the same as the configurations illustrated in the left frame of FIG. 13, and the processing amounts and the communication amounts are also the same as the values illustrated in the left column of FIG. 13. Furthermore, in FIG. 16, section (a) is common to section (a) of FIG. 14 described above, and thus description thereof is omitted here.

Section (b) of FIG. 16 illustrates models by the AI device #1 (AI device 20a) and the AI device #2 (AI device 20b) in a case where the dividing position is determined by giving priority to the power consumption. In a case where the dividing position is determined by giving priority to the transmission speed, the capability value, the power consumption value, and the like of the AI device #1, the AI device #2, and the transmission path 31 as described above are not used.

When the dividing position is determined by giving priority to the transmission speed, in the neural network distribution server 10, the neural network control unit 110 determines the dividing position on the basis of the communication amount between the respective adjacent layers L-1 to L-7. In the example of FIG. 16, with reference to the “communication amount” column in section (a), the communication amount between the adjacent layers L-5 is the smallest among the respective adjacent layers L1 to L-7. Therefore, the neural network control unit 110 determines the adjacent layers L-5 as the dividing position.

As described above, in the information processing system 1 according to the embodiment, in a case where the execution neural network is divided at the dividing position and distributed to the plurality of AI devices, the dividing position is determined on the basis of the processing amount of each layer and the transmission amount between respective adjacent layers calculated from the execution neural network, the actual measurement result of the processing capability of each AI device actually measured using the measurement neural network, and the transmission capability of the transmission path between the AI devices. Therefore, by applying the information processing system 1 according to the embodiment, it is possible to divide and distribute the execution neural network at a more appropriate dividing position.

In addition, in the information processing system 1 according to the embodiment, even if a large number of parameters are not transmitted by the command GetCapabilities, the details of the performance of each AI device or the like can be known by the benchmark actual measurement by the measurement neural network, so that the performance parameters can be easily managed.

Furthermore, in the information processing system 1 according to the embodiment, in a case where the execution neural network is divided and distributed to a plurality of AI devices, it is possible to determine an appropriate dividing position from various viewpoints according to, for example, the application of the execution neural network, and the like.

### (5. First Modification of Embodiment)

Next, a first modification of the embodiment will be described. The first modification of the embodiment is an example of an information processing system including three or more AI devices. FIG. 17 is a schematic diagram illustrating a configuration of an example of an information processing system according to the first modification of the embodiment.

In FIG. 17, the information processing system according to the first modification of the embodiment includes three AI devices of the AI device 20a, the AI device 20b, and an AI device 20c. The AI device 20a and the AI device 20b are connected by a transmission path 31a, and the AI device 20b and the AI device 20c are connected by a transmission path 31b. The AI device 20a is built in or externally connected to the imaging device 2100, and a captured image captured by the imaging device 2100 is used as input data. In the AI device 20b, the output of the AI device 20a supplied via the transmission path 31a is used as input data. Furthermore, in the AI device 20c, the output of the AI device 20b supplied via the transmission path 31b is used as input data.

Note that, in FIG. 17, the AI device 20a, the AI device 20b, and the AI device 20c are also illustrated as an AI device #1, an AI device #2, and an AI device #3, respectively.

The AI device 20a is what is called an edge processing device. The AI device 20b is what is called a backyard processing device such as an edge box, and has higher processing capability than the AI device 20a. Furthermore, the AI device 20c is, for example, an information processing device configured on a cloud neural network, and has higher processing capability than the AI device 20b.

Furthermore, it is possible to extremely increase the transmission speed between the imaging device 2100 and the AI device 20a. In particular, in a case where the imaging device 2100 includes one semiconductor chip as described with reference to FIGS. 5A and 5B and is built in the AI device 20a, the latency in the transmission path can be set to approximately zero.

The transmission speed of the transmission path 31a connecting the AI device 20a and the AI device 20b is lower than that of the transmission path connecting the imaging device 2100 and the AI device 20a. Furthermore, the transmission speed of the transmission path 31b connecting the AI device 20b and the AI device 20c is further reduced with respect to the transmission path 31a. On the other hand, in a case where an information processing device on a cloud neural network is used as the AI device 20c, the AI device 20c can have much higher processing capability than the AI devices 20a and 20b.

Although not illustrated in FIG. 17, each of the AI devices 20a to 20c is connected to the neural network distribution server 10, and each division execution neural network in which the execution neural network is divided into three by two dividing positions is supplied.

The neural network distribution server 10 may determine the two dividing positions of the execution neural network by extending the method described in the embodiment. As an example, the neural network distribution server 10, the neural network distribution server 10 transmits the measurement neural network to the AI device 20a and the AI device 20b using the method described with reference to FIG. 10 in the embodiment, and causes the AI device 20a and the AI device 20b to execute the benchmark processing using the measurement neural network. By using this execution result, dividing positions of the execution neural network with respect to the AI devices 20a and 20b are determined.

Next, the neural network distribution server 10 similarly transmits the measurement neural network to the AI device 20b and the AI device 20c, and executes the benchmark processing using the measurement neural network. At this time, for the AI device 20b, the neural network distribution server 10 may set a layer subsequent to the dividing position determined with the AI device 20a as a target of the benchmark processing. The neural network distribution server 10 uses this execution result to determine the dividing positions of the execution neural network for the AI devices 20b and 20c.

Note that, in the above description, the dividing position is determined from the upstream side of the data, that is, the side of the AI device 20a, but this is not limited to this example, and the dividing position may be determined from the downstream side of the data, that is, the side of the AI device 20c. Furthermore, in the above description, the execution neural network is distributed to the three AI devices 20a to 20c, but this is not limited to this example. That is, the first modification of the embodiment can also be applied to a case where the execution neural network is distributed to four or more AI devices by extending the method of distributing the execution neural network to the above-described three AI devices 20a to 20c.

As described above, in the information processing system according to the first modification of the embodiment, the execution neural network can be distributed to three or more AI devices.

### (6. Second Modification of Embodiment)

Next, a second modification of the embodiment will be described.

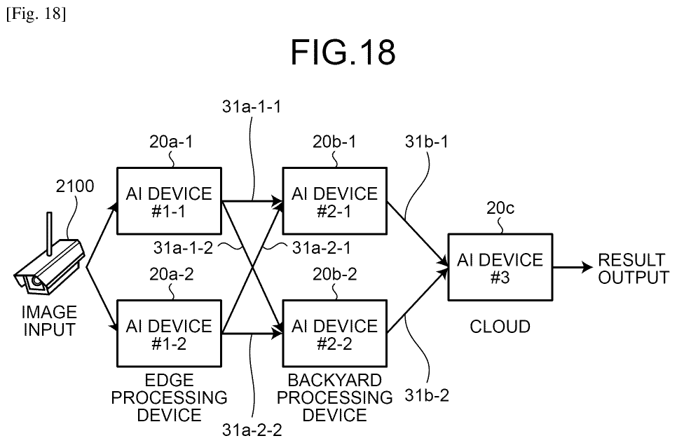

The second modification of the embodiment is an example in which the processing capability as a whole is enhanced by switching a plurality of AI devices in a time division manner. FIG. 18 is a schematic diagram illustrating a configuration of an example of an information processing system according to a second modification of the embodiment;

The information processing system according to the second modification of the embodiment includes AI devices 20a-1 and 20a-2, AI devices 20b-1 and 20b-2, and the AI device 20c. The AI devices 20a-1 and 20a-2 and the AI devices 20b-1 and 20b-2 are connected in parallel. Note that, in the example of FIG. 18, the AI devices 20a-1 and 20a-2 connected in parallel are each an edge processing device, and the AI devices 20b-1 and 20b-2 similarly connected in parallel are each a backyard processing device. Furthermore, the AI device 20c includes, for example, an information processing device on a cloud neural network.

Although not illustrated in FIG. 18, each of the AI devices 20a-1, 20a-2, 20b-1, 20b-2, and 20c is connected to the neural network distribution server 10. The neural network distribution server 10 divides the execution neural network into three by two dividing positions, and distributes the divided three division execution neural networks to, for example, a set of the AI devices 20a-1 and 20a-2, a set of the AI devices 20b-1 and 20b-2, and the AI device 20c. As a method of determining the dividing position of the three division execution neural networks, the method described in the first modification of the embodiment can be applied.

Note that the benchmark processing by the measurement neural network may be executed in parallel by operating the AI devices 20a-1 and 20a-2 in a time division manner, for example. The same applies to the AI devices 20b-1 and 20b-2.

The output of the imaging device 2100 is input to each of the AI devices 20a-1 and 20a-2. The output of the AI device 20a-1 is supplied to the AI devices 20b-1 and 20b-2 via transmission paths 31a-1-1 and 31a-1-2, respectively. Similarly, the output of the AI device 20a-2 is supplied to the AI devices 20b-1 and 20b-2 via transmission paths 31a-2-1 and 31a-2-2, respectively. The outputs of the AI devices 20b-1 and 20b-2 are supplied to the AI device 20c via the transmission paths 31b-1 and 31b-2, respectively.

In such a configuration, the AI devices 20a-1 and 20a-2 are alternately operated in time division in synchronization with the frame timing of the image data output from the imaging device 2100. For example, the AI device 20a-1 is caused to execute processing of an odd-numbered frame, and the AI device 20a-2 is caused to execute processing of an even-numbered frame. Similarly, the AI devices 20b-1 and 20b-2 are alternately operated in synchronization with the frame timing.

As described above, according to the second modification of the embodiment, the processing by the AI devices 20a-1 and 20a-2 can be executed in parallel, and the processing by the AI devices 20b-1 and 20b-2 can be executed in parallel. Therefore, for example, even in a case where the AI devices 20a-1 and 20b-1 require time of one frame or more (and less than one frame) for data processing for one frame, the processing can be executed without delay.

As described above, the information processing system according to the second modification of the embodiment can also cope with distribution of the execution neural network for more complicated connection.

Note that, in the above-described embodiment and the first and second modifications of the embodiment, the processing capability of each AI device is acquired using the definition of NICE, but this is not limited to this example. That is, the embodiment and the first and second modifications of the embodiment are also applicable to a system that does not use NICE.

Note that the effects described in the present specification are merely examples and are not limited, and other effects may be provided.

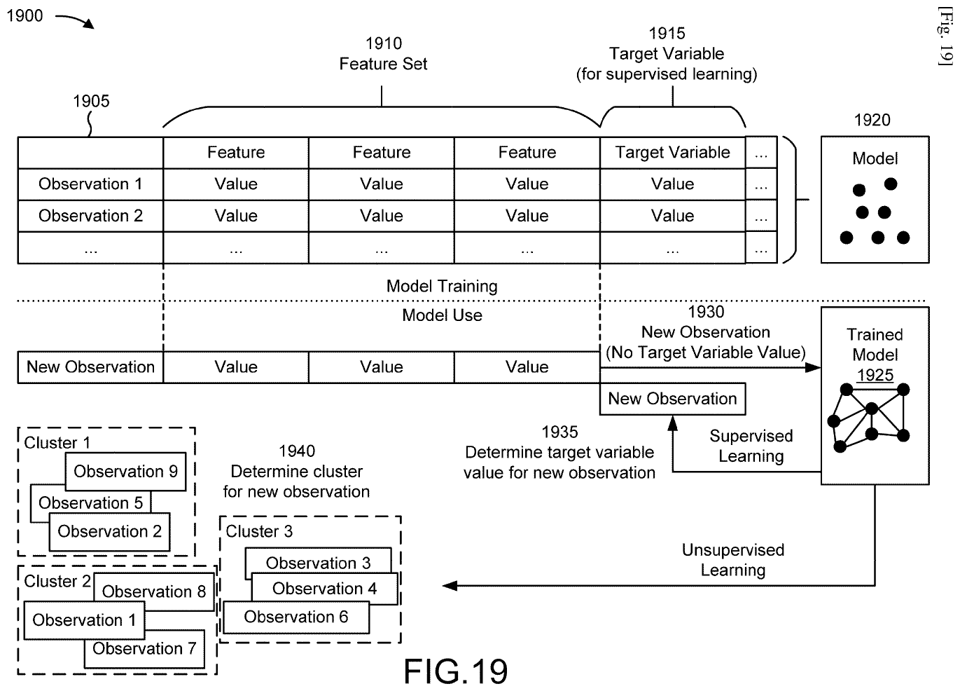

FIG. 19 is a diagram illustrating an example 1900 of training and using a machine learning model in connection with computer vision and/or image processing (e.g., object detection, facial recognition, and/or image segmentation, among other examples). This machine learning model may be used to develop the DNN, which is subsequently segmented, in accordance with embodiments of the disclosure outlined above. The machine learning model training and usage described herein may be performed using a machine learning system. The machine learning system may include, or may be included in, a computing device, a server, and/or a cloud computing environment, among other examples, such as the image processing system, as described in more detail elsewhere herein.

As shown by reference number 1905, a machine learning model may be trained using a set of observations. The set of observations may be obtained from training data (e.g., historical visual observation data associated with visual records and/or image data), such as data gathered during one or more processes described herein. In some implementations, the machine learning system may receive the set of observations (e.g., as input) from the image processing system, as described elsewhere herein.

As shown by reference number 1910, the set of observations (e.g., visual observation data) may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the image processing system For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include features of color distribution, texture features, shape descriptors, edge features, corner features, object sizes, area proportions, orientations, aspect ratios, and/or color dominance, among other examples. As shown, for a first observation, the features may have values of color histogram values, texture attribute values, shape moment values, edge response values, corner response values, object size values, area proportion values, orientation values, aspect ratio values, color dominance values, and/or gradient magnitudes, among other examples. These features and feature values are provided as examples and may differ in other examples.

As shown by reference number 1915, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, and/or labels, among other examples) and/or may represent a variable having a Boolean value. A target variable may be associated with a target variable value, and a target variable value may be specific to an observation. In example 1900, the target variable may be an object category (e.g., associated with identifying the category or type of an object in an image), emotion recognition (e.g., associated with predicting the emotion expressed in a facial image), segmentation mask (e.g., associated with generating pixel-level segmentation masks to outline and classify different regions or objects in an image), pose estimation (e.g., associated with predicting the pose or orientation of an object in an image), image quality assessment (e.g. associated with estimating the quality of an image), anomaly detection (e.g., associated with identifying unusual or anomalous regions in an image), image captioning (e.g., associated with generating descriptive captions or textual explanations for the content of an image), age estimation (e.g., associated with predicting an age of individuals depicted in an image), optical character recognition (OCR) (e.g., associated with recognizing and extracting text from images, image similarity (e.g., associated with calculating similarity scores between images to group similar images together), among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 1920, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 1925 to be used to analyze new observations.

As an example, the machine learning system may obtain training data for the set of observations based on image preprocessing techniques, as described in more detail elsewhere herein.

As shown by reference number 1930, the machine learning system may apply the trained machine learning model 1925 to a new observation (e.g., a new visual observation), such as by receiving a new observation and inputting the new observation to the trained machine learning model 1925. In the context of image processing, a new observation may include features of image pixel values, edge maps, among other examples). The machine learning system may apply the trained machine learning model 1925 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 1925 may predict a value of tree for the target variable of “type of object present in an image” for the new observation, as shown by reference number 1935. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a suggested object category of tree. The first automated action may include, for example, classifying the object into an object category of tree.

In some implementations, the trained machine learning model 1925 may classify (e.g., cluster) the new observation in a cluster, as shown by reference number 1940. The observations within a cluster may have a threshold degree of similarity. For example, if the historical records indicate similar image characteristics, then the images likely depict related objects. As an example, if the machine learning system classifies the new observation in a first cluster (e.g., trees), then the machine learning system may provide a first recommendation, such as the first recommendation described above.

As another example, if the machine learning system were to classify the new observation in a second cluster (e.g., a face), then the machine learning system may provide a second (e.g., different) recommendation (e.g., suggest an object category of the face, if desired).

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 1925 may be retrained using feedback information. For example, feedback may be provided to the machine learning model. The feedback may be associated with actions performed based on the recommendations provided by the trained machine learning model 1925 and/or automated actions performed, or caused, by the trained machine learning model 1925. In other words, the recommendations and/or actions output by the trained machine learning model 1925 may be used as inputs to re-train the machine learning model (e.g., a feedback loop may be used to train and/or update the machine learning model). For example, the feedback information may include a correct object category suggestion that is an output from the model.

In this way, the machine learning system may apply a rigorous and automated process to computer vision and/or image processing, as described in more detail elsewhere herein. The machine learning system may enable recognition and/or identification of tens, hundreds, thousands, or millions of features and/or feature values for tens, hundreds, thousands, or millions of observations, thereby increasing accuracy and consistency and reducing delay associated with computer vison and/or image processing relative to requiring computing resources to be allocated for tens, hundreds, or thousands of operators to manually process visual observations and/or images using the features or feature values.

As indicated above, FIG. 19 is provided as an example. Other examples may differ from what is described in connection with FIG. 19.

Note that the present technology can also have the following configurations.

(1)

An information processing system comprising:
circuitry configured to
   transmit a first command to a first electronic device requesting processing capability information of the first electronic device;
   receive first parameters from the first electronic device in response to the first command;
divide a deep neural network (DNN) into at least a first DNN and a second DNN based on the first parameters received from the first electronic device; and
transmit the first divided DNN to the first electronic device.
   (2)

The information processing system of (1), wherein the circuitry is configured to:
transmit a second command to a second electronic device requesting processing capability information of the second electronic device;
receive second parameters from the second electronic device in response to the second command;
divide the DNN into the first divided DNN and the second divided DNN based on the first parameters received from the first electronic device and the second parameters received from the second electronic device; and
transmit the second divided DNN to the second electronic device.
   (3)

The information processing system of any of (1) to (2), wherein
the first parameters correspond to artificial intelligence (AI) processing capabilities of the first electronic device.
   (4)

The information processing system of any of (1) to (3), wherein
the circuitry is configured to divide the DNN into at least the first DNN and the second DNN based at least on the first AI parameters received from the first electronic device.
   (5)

The information processing system of any of (2) to (4), wherein
the first parameters correspond to AI processing capabilities of the first electronic device and the second parameters correspond to AI processing capabilities of the second electronic device.
   (6)

The information processing system of any of (2) to (5), wherein
the circuitry is configured to divide the DNN into at least the first DNN and the second DNN based on the first AI parameters received from the first electronic device and the second AI parameters received from the second electronic device.
   (7)

The information processing system of any of (1) to (6), wherein
the first parameters received from the first electronic device correspond to computational processing capabilities of the first electronic device.
   (8)

The information processing system of any of (2) to (7), wherein
the first parameters received from the first electronic device correspond to computational processing capabilities of the first electronic device, and
the second parameters received from the second electronic device correspond to computational processing capabilities of the second electronic device.
   (9)

The information processing system of any of (1) to (8), wherein
the first parameters received from the first electronic device correspond to memory capabilities of the first electronic device.
   (10)

The information processing system of any of (2) to (9), wherein
the first parameters received from the first electronic device correspond to memory capabilities of the first electronic device, and
the second parameters received from the second electronic device correspond to memory capabilities of the second electronic device.
   (11)

The information processing system of any of (1) to (10), wherein
the first parameters received from the first electronic device correspond to a hardware architecture of the first electronic device.
   (12)

The information processing system of any of (2) to (11), wherein
the first parameters received from the first electronic device correspond to a hardware architecture of the first electronic device, and
the second parameters received from the first electronic device correspond to a hardware architecture of the second electronic device.
   (13)

The information processing system of any of (1) to (12), further comprising:
a computing system comprising the circuitry; and
the first electronic device.
   (14)

The information processing system of any of (1) to (13), wherein
the first electronic device comprises
   an image sensor configured to acquire image data;
   a communication interface configured to receive at least the first DNN from the computing system; and
   processing circuitry configured to execute at least the first DNN based on the acquired image data.
      (15)

The information processing system of (14), wherein
the communication interface is configured to transmit a result of the executed at least first DNN to a second electronic device.
   (16)

The information processing system of any of (1) to (15), further comprising:
a computing system comprising the circuitry;
the first electronic device; and
the second electronic device.
   (17)

The information processing system of (16), wherein the first electronic device comprises:
an image sensor configured to acquire image data;
a first communication interface configured to receive at least the first DNN from the computing system; and
first processing circuitry configured to execute at least the first DNN based on the acquired image data, wherein
the first communication interface is configured to transmit a result of the executed at least first DNN to the second electronic device.
   (18)

The information processing system of (17), wherein the second electronic device comprises:
a second communication interface configured to receive at least the second DNN from the computing system and the result of the executed at least first DNN from the first electronic device; and
second processing circuitry configured to execute at least the second DNN based on the result of the executed at least first DNN received from the first electronic device.
   (19)

The information processing system of (18), wherein
the second communication interface is configured to output a result of the executed at least the second DNN to the computing system.
   (20)

The information processing system of any of (1) to (19), wherein
the information processing system is a server.
   (21)

The information processing system of any of (1) to (20), wherein
the information processing system is configured as a plurality of communicatively coupled information processing devices.
   (22)

One or more non-transitory computer-readable media comprising computer-program instructions, which when executed by one or more information processing devices, cause the one or more information processing devices to:
transmit a first command to a first electronic device processing capability information of the first electronic device;
receive first parameters from the first electronic device in response to the first command;
divide a deep neural network (DNN) into at least a first DNN and a second DNN based on the first parameters received from the first electronic device; and
transmit the first divided DNN to the first electronic device.
   (23)

A method performed by an information processing system, the method comprising:
transmitting a first command to a first electronic device processing capability information of the first electronic device;
receiving first parameters from the first electronic device in response to the first command;
dividing a deep neural network (DNN) into at least a first DNN and a second DNN based on the first parameters received from the first electronic device; and
transmitting the first divided DNN to the first electronic device.
   (24)

An electronic device comprising:
circuitry configured to
   receive a command requesting the electronic device to provide processing capability information of the electronic device;
   transmit, responsive to the command, parameters indicating processing capabilities at the electronic device;
   receive a first deep neural network (DNN) for execution responsive to transmitting the parameters; and
   execute the first DNN on captured image data or data received from another electronic device.
      (25)

The electronic device of (24), further comprising:
an image sensor configured to capture image data, wherein
the circuitry is configured to execute the DNN based on the image data captured by the image sensor.
   (26)

The electronic device of (25), wherein
the circuitry is configured to transmit a result of the executed DNN to another electronic device for further processing.
   (27)

The electronic device of any of (24) to (26), wherein
the circuitry is configured to receive, as the data received from another electronic device, a result of an execution of a second DNN at another electronic device.
   (28)

The electronic device of (27), wherein
the circuitry is configured to execute the first DNN based on the data received from the another electronic device.
   (29)

The electronic device of (28), wherein
the communication interface is configured to transmit a result of execution of the first DNN to an information processing system.
   (30)

A non-transitory computer-readable medium including computer program instructions, which when executed by an electronic device, causes the electronic device to:
receive a command requesting the electronic device to provide processing capability information of the electronic device;
transmit, responsive to the command, parameters indicating processing capabilities at the electronic device;
receive a first deep neural network (DNN) for execution responsive to transmitting the parameters; and
execute the first DNN on captured image data or data received from another electronic device.
   (31)

A method performed by an electronic device, the method comprising:
receiving a command requesting the electronic device to provide processing capability information of the electronic device;
transmitting, responsive to the command, parameters indicating processing capabilities at the electronic device;
receiving a first deep neural network (DNN) for execution responsive to transmitting the parameters; and
executing the first DNN on captured image data or data received from another electronic device.

### REFERENCE SIGNS LIST

1 Information processing system
10 Neural network distribution server
20a, 20a-1, 20a-2, 20b, 20b-1, 20b-2, 20c AI device
21 Camera
30a, 30b, 31, 31a, 31b, 31a-1-1, 31a-1-2, 31a-2-1, 31a-2-2, 31b-1, 31b-2 Transmission path
40 Input layer
41-1, 41-2, 41-3, 41-4, 41-5 Convolution layer
42 Fully connected layer
43 Output layer
110 Neural network control unit
111 Neural network storage unit
210 Neural network storage part
211 Neural network execution unit
2010 Imaging block
2020 Signal processing block
2100 Imaging device

1. An information processing system comprising:
circuitry configured to
transmit a first command to a first electronic device requesting processing capability information of the first electronic device;
receive first parameters from the first electronic device in response to the first command;
divide a deep neural network (DNN) into at least a first DNN and a second DNN based on the first parameters received from the first electronic device; and
transmit the first divided DNN to the first electronic device.

2. The information processing system of claim 1, wherein the circuitry is configured to:
transmit a second command to a second electronic device requesting processing capability information of the second electronic device;
receive second parameters from the second electronic device in response to the second command;
divide the DNN into the first divided DNN and the second divided DNN based on the first parameters received from the first electronic device and the second parameters received from the second electronic device; and
transmit the second divided DNN to the second electronic device.

3. The information processing system of claim 1, wherein
the first parameters correspond to artificial intelligence (AI) processing capabilities of the first electronic device.

4. The information processing system of claim 1, wherein
the circuitry is configured to divide the DNN into at least the first DNN and the second DNN based at least on the first AI parameters received from the first electronic device.

5. The information processing system of claim 2, wherein
the first parameters correspond to AI processing capabilities of the first electronic device and the second parameters correspond to AI processing capabilities of the second electronic device.

6. The information processing system of claim 2, wherein
the circuitry is configured to divide the DNN into at least the first DNN and the second DNN based on the first AI parameters received from the first electronic device and the second AI parameters received from the second electronic device.

7. The information processing system of claim 1, wherein
the first parameters received from the first electronic device correspond to computational processing capabilities of the first electronic device.

8. The information processing system of claim 2, wherein
the first parameters received from the first electronic device correspond to computational processing capabilities of the first electronic device, and
the second parameters received from the second electronic device correspond to computational processing capabilities of the second electronic device.

9. The information processing system of claim 1, wherein
the first parameters received from the first electronic device correspond to memory capabilities of the first electronic device.

10. The information processing system of claim 2, wherein
the first parameters received from the first electronic device correspond to memory capabilities of the first electronic device, and
the second parameters received from the second electronic device correspond to memory capabilities of the second electronic device.

11. The information processing system of claim 1, wherein the first parameters received from the first electronic device correspond to a hardware architecture of the first electronic device.

12. The information processing system of claim 2, wherein
the first parameters received from the first electronic device correspond to a hardware architecture of the first electronic device, and
the second parameters received from the first electronic device correspond to a hardware architecture of the second electronic device.

13. The information processing system of claim 1, further comprising:
a computing system comprising the circuitry; and
the first electronic device.

14. The information processing system of claim 13, wherein
the first electronic device comprises
an image sensor configured to acquire image data;
a communication interface configured to receive at least the first DNN from the computing system; and
processing circuitry configured to execute at least the first DNN based on the acquired image data.

15. The information processing system of claim 14, wherein
the communication interface is configured to transmit a result of the executed at least first DNN to a second electronic device.

16. The information processing system of claim 2, further comprising:
a computing system comprising the circuitry;
the first electronic device; and
the second electronic device.

17. The information processing system of claim 16, wherein the first electronic device comprises:
an image sensor configured to acquire image data;
a first communication interface configured to receive at least the first DNN from the computing system; and
first processing circuitry configured to execute at least the first DNN based on the acquired image data, wherein
the first communication interface is configured to transmit a result of the executed at least first DNN to the second electronic device.

18. The information processing system of claim 17, wherein the second electronic device comprises:
a second communication interface configured to receive at least the second DNN from the computing system and the result of the executed at least first DNN from the first electronic device; and
second processing circuitry configured to execute at least the second DNN based on the result of the executed at least first DNN received from the first electronic device.

19. The information processing system of claim 18, wherein
the second communication interface is configured to output a result of the executed at least the second DNN to the computing system.

20. The information processing system of claim 1, wherein
the information processing system is a server.

21. The information processing system of claim 1, wherein
the information processing system is configured as a plurality of communicatively coupled information processing devices.

22. One or more non-transitory computer-readable media comprising computer-program instructions, which when executed by one or more information processing devices, cause the one or more information processing devices to:
transmit a first command to a first electronic device processing capability information of the first electronic device;
receive first parameters from the first electronic device in response to the first command;
divide a deep neural network (DNN) into at least a first DNN and a second DNN based on the first parameters received from the first electronic device; and
transmit the first divided DNN to the first electronic device.

23. An electronic device comprising:
circuitry configured to
receive a command requesting the electronic device to provide processing capability information of the electronic device;
transmit, responsive to the command, parameters indicating processing capabilities at the electronic device;
receive a first deep neural network (DNN) for execution responsive to transmitting the parameters; and
execute the first DNN on captured image data or data received from another electronic device.

24. The electronic device of claim 23, further comprising:
an image sensor configured to capture image data, wherein
the circuitry is configured to execute the DNN based on the image data captured by the image sensor.

25. The electronic device of claim 24, wherein
the circuitry is configured to transmit a result of the executed DNN to another electronic device for further processing.

26. The electronic device of claim 23, wherein
the circuitry is configured to receive, as the data received from another electronic device, a result of an execution of a second DNN at another electronic device.

27. The electronic device of claim 26, wherein
the circuitry is configured to execute the first DNN based on the data received from the another electronic device.

28. The electronic device of claim 27, wherein
the communication interface is configured to transmit a result of execution of the first DNN to an information processing system.

29. A non-transitory computer-readable medium including computer program instructions, which when executed by an electronic device, causes the electronic device to:
receive a command requesting the electronic device to provide processing capability information of the electronic device;
transmit, responsive to the command, parameters indicating processing capabilities at the electronic device;
receive a first deep neural network (DNN) for execution responsive to transmitting the parameters; and
execute the first DNN on captured image data or data received from another electronic device.
